(19) United States
(12) Patent Application Publication
(10) Pub. No.: US 2025/0385344 A1
(43) Pub. Date: Dec. 18, 2025

(54) CONJUGATED POLYMER FOR ACIDIC POLYMER-AIR BATTERIES

(71) Applicant: The Texas A&M University System, College Station, TX (US)

(72) Inventors: Jodie Lutkenhaus, College Station, TX (US); Ting Ma, College Station, TX (US)

(21) Appl. No.: 19/235,020

(22) Filed: Jun. 11, 2025

Related U.S. Application Data
(60) Provisional application No. 63/658,936, filed on Jun. 12, 2024.

(51) Int. Cl. H01M 12/04; H01M 4/02; H01M 4/60; H01M 4/86; H01M 4/92; H01M 50/437; H01M 50/44

(52) U.S. Cl. CPC H01M 12/04; H01M 4/608; H01M 4/8605; H01M 4/926; H01M 50/437; H01M 50/44; H01M 2004/027; H01M 2004/8689; H01M 2300/0011

(57) ABSTRACT

The present disclosure provides for aqueous polymer-air batteries that have several advantages over other technologies such as improved safety, lower cost, higher ionic conductivity, and sustainability. In an aspect, the present disclosure provides for an acidic polymer-air battery that includes an anode including compositions including a conjugated ladder polymers as a stable anode for acidic-polymer air batteries.

### CROSS-REFERENCE TO RELATED APPLICATIONS

This application claims the benefit of U.S. Provisional Application entitled “CONJUGATED POLYMER FOR ACIDIC POLYMER-AIR BATTERIES” and having Ser. No. 63/658,936, filed Jun. 12, 2024, which is herein incorporated by reference in its entirety.

### BACKGROUND

Metal-air batteries are based on the use of a metal anode and an oxygen cathode, which have been widely studied for their potential as a high-density energy storage solution. But the use of metal anodes in air batteries is limited by the availability, sustainability, cost, and environmental impact of extracting and processing metal resources. In addition, dendrites, passivation, and corrosion on the metal anode (Li, Na, Al, Mg, Fe, Zn, etc.) lead to various problems. In an effort to address these limitations, researchers have explored alternative polymer anodes, but the use of polymer anodes also have various problems that need to be overcome.

The development of one or more aspects this invention(s), at least in part, was funded by a grant from The Welch Foundation—Grant No. A-2070-20210327.

### SUMMARY

The present disclosure provides for an acidic polymer-air battery that includes an anode including compositions including a conjugated ladder polymers as a stable anode for acidic-polymer air batteries.

The present disclosure provides for an acidic polymer-air battery that include an anode that comprises the conjugated ladder polymer having the following structure:

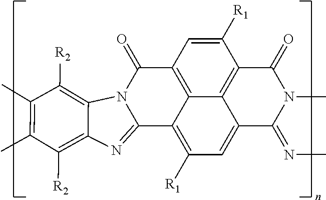

wherein each R₁ and each R₂ are independently selected from H, an alkyl, an ethylene oxide, a charge group, one or more of the structures shown below:

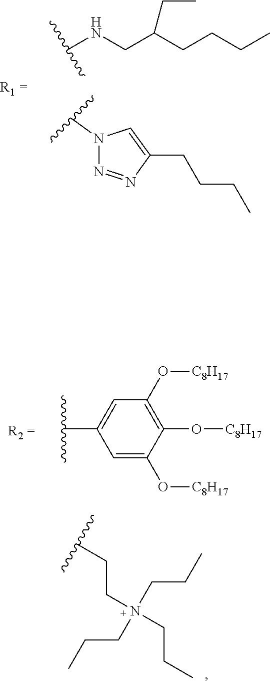

or a combination of any thereof.

The present disclosure provides for methods of assembling an acidic polymer-air battery. In an aspect, the method can include placing an anode within a battery housing, where the anode comprises a conjugated ladder polymer as described above and herein. The method can include placing an air cathode within the battery housing at an opposite end of the battery housing to the anode, placing a separator within the battery housing between the anode and the cathode, and filling the battery housing with an electrolyte.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A-1D illustrate (FIG. 1A) cyclic voltammograms of a BBL anode with various scan rates between 5 and 25 mV·s⁻¹; (FIG. 1B) A log-log plot of the peak current versus scan rate to obtain the b-value; (FIG. 1C) Schematic diagram of the in-situ conductance set-up; and (FIG. 1D) In situ conductance of BBL versus applied potential. The working electrode for the CV and conductance measurements was drop-cast BBL on glassy carbon and interdigitated electrode, respectively. The aqueous electrolyte was 0.5 M H₂SO₄. Pt wire and Ag/AgCl/sat. KCl was the counter and reference electrodes, respectively. E_{bias}=10 mV, scan rate=5 mV·s⁻¹ for the conductance measurement.

FIG. 2 shows the proposed electrode reactions of the BBL-air battery in aqueous H₂SO₄ electrolyte as well as a schematic of the acidic polymer-air battery.

FIGS. 3A-3C show a redox mechanism investigation using in situ Raman spectroscopy. FIG. 3A shows a schematic diagram of the in situ Raman set-up. FIG. 3B shows a 2D mapping of the Raman spectra of the BBL electrode during the charge-discharge process. FIG. 3C shows a chemical structure and Raman spectra of the BBL electrode at specific voltages. The Raman spectra of BBL were taken using 532 nm excitation in the range 900-1800 cm⁻¹.

FIGS. 4A-4D show a real-time cyclic voltammetry QCM-D. FIG. 4A shows time-dependent changes in frequency and dissipation (3rd, 5th, 7th overtones) for two complete oxidation and reduction cycles of BBL. FIG. 4B shows mass profiles for BBL during cyclic voltammetry. FIG. 4C shows mass change versus charge during polarization. FIG. 4D shows apparent molecular weight (Mw′) of the transferred species during cyclic voltammetry. The working electrode was a BBL-coated sensor with an electrolyte of 0.5 M H₂SO₄/H₂O. Pt plate and Ag/AgCl/Sat. KCl were the counter and reference electrodes, respectively. The scan rate was 5 mV·s⁻¹. The dark red curves describe oxidation, and the dark blue curves describe reduction.

FIGS. 5A-5D show in situ EIS/QCM-D of a BBL electrode. FIG. 5A shows time-dependent changes in frequency, dissipation, charge, and mass of the BBL-coated quartz crystal during EIS. FIG. 5B shows mass change versus charge during a sine cycle. FIG. 5C shows mass change and charge with sine potential amplitude of 10 mV. FIG. 5D shows apparent molecular weight (Mw′) of the transferred species during an EIS cycle. The DC voltage is 85 mV (vs. Ag/AgCl/Sat. KCl) at 10 mHz.

FIGS. 6A-6D show a BBL-air battery. FIG. 6A shows charge-discharge curves of a three-electrode cell with BBL@CNTs as the working electrode, Pt wire, and Ag/AgCl/Sat. KCl as the counter and reference electrode, respectively. FIG. 6B shows charge-discharge curves of the full BBL-air batteries with BBL@CNTs as the anode and an air cathode catalyzed by Pt/C. FIG. 6C shows Ragone plots of reported polymer-air battery estimated from the reported practical capacities at specific current densities.¹⁷⁻²⁴ FIG. 6D shows cycling stability of the full BBL-air battery. Insets show photographs of a BBL@CNTs self-standing electrode and the assembled full BBL-air battery. The electrolyte is 0.5 M H₂SO₄/H₂O.

FIG. 7 shows an overview of Example 2.

FIG. 8 shows examples of proposed BBL derivatives with different side-chains and chain-ends.

FIG. 9 shows chemical structure and Raman spectra of a BBL electrode at specific voltages.

FIGS. 10A-10B show real-time EQCMD. (FIG. 10A) Mass profiles for BBL during cyclic voltammetry. (FIG. 10B) Apparent molecular weight (Mw′) of the transferred species during cyclic voltammetry.

FIG. 11 shows real-time conductance of BBL during cyclic voltammetry.

FIG. 12 shows molecular structures of proposed polycations and polyanions.

FIG. 13 shows a linear sweep voltammetry related to the scheme in FIG. 2. The ORR and OER currents of Pt/C in 0.5 M H₂SO₄/H₂O at 5 mV/s. The forward and backward scans overlap.

FIG. 14 shows a Raman spectra of BBL related to FIGS. 3A-3C. The Raman spectra of a BBL electrode in the extended 250-2000 cm⁻¹ range during the charge discharge process. A three-electrode set-up with BBL@CNTs as the working electrode, carbon rod as the counter electrode, and Ag/AgCl as the reference electrode in 0.5 M H₂SO₄/H₂O was used.

FIGS. 15A-15B show EQCM-D of BBL related to FIGS. 4A-4D. FIG. 15A shows time and FIG. 15B shows potential-dependent changes in frequency and dissipation (3^{rd}, 5^{th}, 7^{th} overtones) of BBL during cyclic voltammetry at 5 mV/s. The working electrode was a BBL-coated QSense sensor, and the electrolyte was 0.5 M H₂SO₄/H₂O. Pt plate and Ag/AgCl were the counter and reference electrodes, respectively.

FIG. 16 shows EQCM-D related to FIGS. 5A-5D. Time-dependent changes in frequency and dissipation of the BBL-coated quartz crystal during EIS. The DC voltage was the reduction peak potential (85 mV vs. Ag/AgCl) of the BBL electrode in 0.5 M H₂SO₄/H₂O, and the AC voltage was 10 mV.

FIGS. 17A-17D show EQCM-D related to FIGS. 5A-5D. Time-dependent frequency and dissipation changes and charge and mass profiles at 85 mV and 4 mV vs. Ag/AgCl.

FIG. 18 shows a photograph, SEM images, and EDS mapping of the BBL@CNTs self-standing electrode related to FIGS. 6A-6D.

FIG. 19 shows a film-forming property comparison. Left is BBL/CNTs=8/2 (wt/wt), and right is BBL/CNTs=7/3 (wt/wt) related to FIGS. 6A-6D.

FIG. 20 shows cycling stability of the BBL@CNTs electrode in 0.5 M H₂SO₄/H₂O in a three-electrode cell related to FIGS. 6A-6D.

FIG. 21 shows ATR-FTIR spectra of the BBL film related to the Experimental Procedures section.

FIG. 22 shows TGA of the BBL film related to the Experimental Procedures section.

FIG. 23 is a table showing a published polymer air battery comparison.

### DETAILED DESCRIPTION

The present disclosure provides for conjugated polymers for acidic polymer-air batteries. Additional features are described below and in the Examples.

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, inorganic chemistry, synthetic chemistry, and the like, which are within the skill of the art. Such techniques are explained fully in the literature.

The following description and examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar or psig. Standard temperature and pressure are defined as 25° C. and 1 bar.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible. Different stereochemistry is also possible, such as products of cis or trans orientation around a carbon-carbon double bond or syn or anti addition could be both possible even if only one is drawn in an embodiment.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### General Discussion

The present disclosure provides for aqueous polymer-air batteries that have several advantages over other technologies such as improved safety, lower cost, higher ionic conductivity, and sustainability. In an aspect, the present disclosure provides for an acidic polymer-air battery that includes an anode including compositions including a conjugated ladder polymer, poly(benzimidazobenzophenanthroline) (BBL) or derivatives thereof as a stable anode for acidic-polymer air batteries. In addition, the anode can include a polyelectrolyte complex and/or an additive material. The present disclosure provides for an anode including a composition that can resolve the limitations of stability, kinetics, and/or conductivity that other technologies suffer. Additional details are in Examples 1-3.

In an aspect, the BBL polymer or derivatives thereof can be used as a drop-in anode material for commercial polymer-air batteries targeted at large-scale energy storage applications such as electric vehicles or grid-level storage. The high capacity, rate capability, high power, and cycling stability demonstrated could enable polymer-air batteries to compete with lithium ion batteries.

In general, the rigid ladder structure, fast kinetics, and high electrical conductivity of the BBL anodes enable its functional performance. The quantified real-time charge transfer mechanism indicates a fast hydronium ion charge compensation process. Also, self-standing BBL anodes can be prepared with an additive material (e.g., carbon material, carbon nanotubes, conducing polymers, conductive (e.g., silver, copper, gold) nanomaterial (e.g., nanowires or nanosheets), and the like) and coupled with Pt/C cathodes to assemble full BBL-air batteries, exhibiting notable rate capabilities (e.g., about 201 mAh·g⁻¹ at 30 A·g⁻¹) and cycling stability (capacity retention of 98.8% compared to the initial value). In an aspect, the nanomaterial can have a thickness of about 1 to 500 nm, about 1 to 350 nm, about 1 to 200, about 1 to 100 nm, about 10 to 500 nm, about 10 to 350 nm, about, about 10 to 200 nm, about 10 to 100 nm, about 50 to 500 nm, about 50 to 350 nm, about 50 to 200 nm, or about 50 to 100 nm. In an aspect, the nanomaterial can have a length and width of about 50 nm to 1 μm, about 50 to 750 nm, about 50 to 500 nm, about 100 nm to 1 μm, about 100 to 750 nm, about 100 to 500 nm, about 250 nm 1 μm, about 250 to 750 nm, or about 250 to 500 nm.

In an aspect, the anode can include a composition including BBL polymer or derivatives thereof. The BBL polymer or derivatives thereof, as described herein, has a unique feature of conjugated ladder structure. The ladder structure includes fused rings with pi conjugation in the backbone leading to a highly rigid and planar chain conformation, which endows the polymer with good stability. The high electron affinity of the BBL polymer or derivatives makes it have a high electrical conductivity. During the redox process, the BBL polymer or derivatives thereof exchanges charge through protonation/deprotonation. The rapid hydronium ion transfer provides fast kinetics.

In an aspect, the BBL polymer or derivatives thereof can be represented by the following structure:

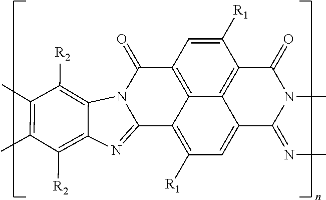

where each R₁ and each R₂ are independently selected from H, an alkyl, an ethylene oxide, a charge group (e.g., amine, sulfonate), a heterocyclic aromatic unit (e.g., benzodithiophene, benzothiadiazole and the structures shown below:

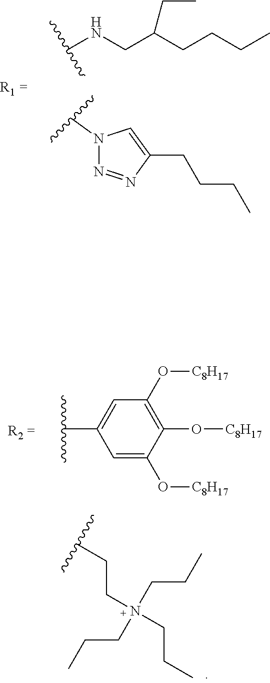

In an aspect, each R₁ and R₂ are H. In another aspect, each R₁ and R₂ can be an alkyl group, an ethylene oxide, a charge group (e.g., amine, sulfonate) and the structures shown below:

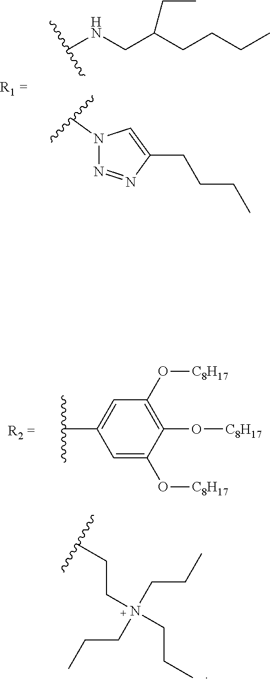

In yet another aspect, each R₁ and R₂ can be one of the structures shown below:

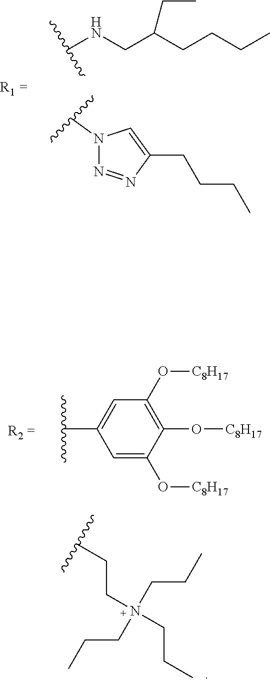

In an aspect, the anode can include an additive material. The additive material can include an additive material such as: carbon materials, conducting polymers, and conductive nanomaterial (e.g., wires, sheets). The carbon material can include carbon nanotubes (CNTs), graphene, MXene, carbon fiber, and the like. The conducting polymer can include PEDOT:PSS, P3HT, F8BT, polyfluorene, polyaniline, polypyrrole, and the like. The conductive nanomaterial (e.g., nanowires, nanosheets) can have dimension(s) in the cm to nm range and can be made of conductive materials (e.g., silver, copper, gold). The conductive wire can have an aspect ratio of about 5 to 1,000,000. The ratio of polymer to additive material can be about 30:70 to 100:0.01 (wt:wt).

In an aspect, the anode can include a polyelectrolyte. The polymer to polyelectrolyte ratio is about 100:0.01 to about 30:70 (wt:wt). The polyelectrolyte can be included in the polymers as shown below:

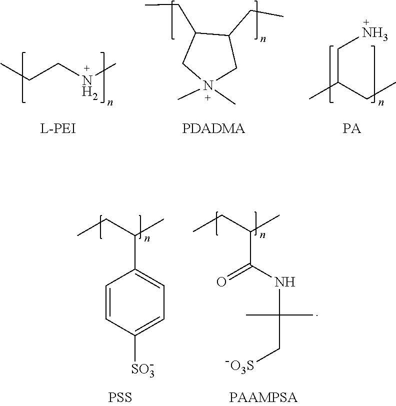

In an aspect, the anode can include the additive material and a polyelectrolyte. The additive material can be those described above and herein and the weight ratio of the polymer to additive material can include those as described above and herein. The polyelectrolyte can be those described above and herein and the weight ratio of the polymer to polyelectrolyte can include those as described above and herein.

Now having described some features of the present disclosure, additional description regarding various aspects is now provided. In an aspect, the present disclosure provides for an acidic polymer-air battery that include an anode that comprises the conjugated ladder polymer (e.g., BBL polymer or derivatives thereof) described herein and above. In an aspect, the anode can also include an additive material selected from: carbon materials, conducting polymers, conductive wire and sheets, or a combination of any thereof. The weight-to-weight ratio of conjugated ladder polymer to additive material is about 30:70 to 100:0.01. The anode can include a polyelectrolyte additive, where the conjugated ladder polymer to polyelectrolyte ratio is about 100:0.01 to about 30:70. In addition, the battery includes a cathode that comprises an air cathode. The air cathode can include a plurality of metal nanoparticles (e.g., platinum (Pt), silver, gold, palladium, copper, combinations thereof and the like) on a surface of a support such as a porous carbon (C) support. The acidic polymer-air battery can also include an electrolyte (e.g., one or more of the following: H₂SO₄, HCl, acetic acid, or phosphoric acid) between the anode and the cathode. The acidic polymer-air battery can also include a glass fiber separator within the electrolyte between the anode and the cathode.

In addition, the present disclosure provides for methods of assembling an acidic polymer-air battery. In an aspect, the method can include placing an anode within a battery housing, where the anode comprises a conjugated ladder polymer as described above and herein. The anode can include one or more additive materials such as carbon materials, conducting polymers, conductive wire and sheets (e.g., conductive nanomaterials), or a combination of any thereof. The method can include placing an air cathode within the battery housing at an opposite end of the battery housing to the anode, placing a separator within the battery housing between the anode and the cathode, and filling the battery housing with an electrolyte. The method can also include sealing the battery housing.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

Metal-air batteries are based on the use of a metal anode and an oxygen cathode, which have been widely studied for their potential as a high-density energy storage solution for various applications, including electric vehicles, renewable energy storage, and portable electronics.¹⁻³ The energy density of metal-air batteries can be very high, as the oxygen cathode provides a much higher capacity than conventional cathodes made of metal oxides. As a plus, aqueous metal-air batteries possess unique merits such as high ionic conductivity, non-flammability, less sensitivity to ambient air, and environmental friendliness.⁴⁻⁷ However, the use of metal anodes in air batteries is limited by the availability, sustainability, cost, and environmental impact of extracting and processing metal resources. In addition, dendrites, passivation, and corrosion on the metal anode (Al, Mg, Fe, Zn, etc.) lead to low utilization and inferior cycling stability.⁸⁻¹¹ Although interfacial modification and electrolyte formulation have been adopted,¹² such issues can still be severe in the presence of oxygen from the air.

To overcome these limitations, researchers have explored alternative polymer anodes, which have several advantages over metal anodes, including low cost, ease of functionalization, and high stability.¹³⁻¹⁶ Recent progress in the development of aqueous polymer-air batteries has been significant. Researchers have developed a range of polymer anode materials, including redox-active quinone polymers,¹⁷⁻²² conducting polymers,²³ and conjugated microporous polymers,²⁴ each with unique properties and performance characteristics in basic or acidic electrolytes. However, there are still several challenges associated with the use of polymer anodes in air batteries. For example, the stability of the polymer anode is limited by its susceptibility to degradation and swelling in the presence of water and oxygen. In addition, the performance of the polymer anode can be limited by its low electrical conductivity and slow electron transfer kinetics. Furthermore, a comprehensive understanding of the charge transport mechanism in the polymer anode is still lacking.

Poly(benzimidazobenzophenanthroline) (BBL) has demonstrated several promising features in transistor applications,²⁵ but BBL has not yet been explored in polymer-air batteries. Among n-type acceptor polymers, BBL has emerged as a versatile choice due to not only its high electron affinity but also its relative stability.²⁶ BBL is a ladder-type polymer that has fused rings with π conjugation in the backbone, leading to a highly rigid and planar chain conformation.^{27,28} BBL has demonstrated high electron mobilities as high as (0.1 cm²·V⁻¹·s⁻¹),^{29,30} transconductance of 9.7 mS,³¹ high electronic conductivity 8 S cm⁻¹ (in a complex),^{32,33} high energy storage capacity (>1000 mAh·g⁻¹ for Li⁺),³⁴ and reversible electrochemistry.^{27,35}

Here, BBL is presented as an anode for aqueous polymer-air batteries. The rigid ladder structure can lend stability, fast kinetics, and high electrical conductivity. In aspects, the present disclosure pairs BBL with a Pt/C cathode which can perform the oxygen reduction reaction (ORR) in discharge and the oxygen evolution reaction (OER) in charging. At the anode side, BBL exchanges charge through protonation/deprotonation. The redox kinetics, electrical conductivity, and real-time charge transfer mechanism of BBL in an acidic electrolyte were quantified. In situ electrochemical quartz crystal microbalance with dissipation monitoring (EQCM-D) measurements demonstrate a fast proton-based charge compensation mechanism for the BBL redox reaction. A self-standing BBL@CNTs electrode was prepared to improve the processability and strength of the BBL electrode, which exhibits excellent rate capability and cycling stability. The full BBL-air battery with BBL@CNTs as the anode coupled with an air cathode catalyzed by Pt/C delivered a high capacity of 201 mAh·g⁻¹ even at 30 A·g⁻¹ with a capacity retention of 98.8% (compared to the initial value) after 500 cycles at 20 A·g⁻¹. The good rate capability and exceptional stability of the BBL anode highlights the potential application of rigid conjugated ladder polymers for polymer-air batteries.

### Results and Discussion

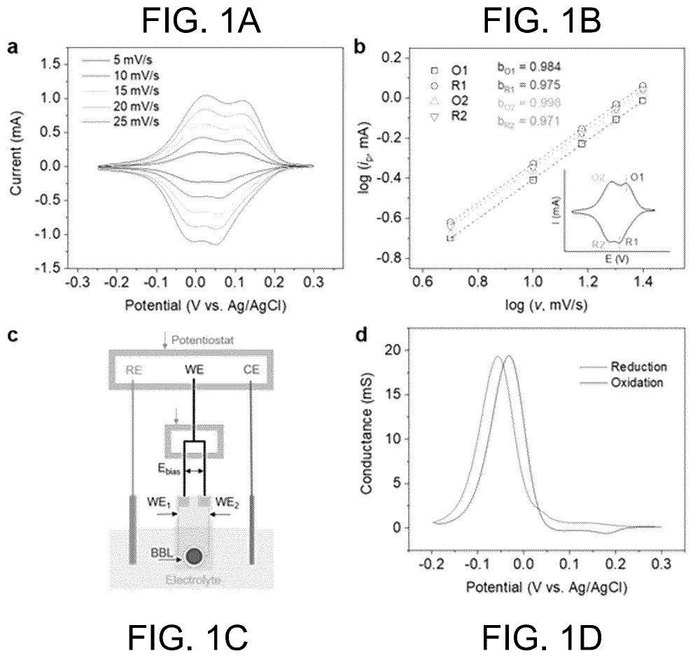

To investigate the feasibility of using BBL as an anode for aqueous polymer-air batteries, the redox behavior, kinetics, and conductance of BBL alone (without additives, loading of 1.0-1.3 mg·cm⁻²) were examined first. The proton storage capability of BBL was investigated in a three-electrode cell with an electrolyte (e.g., H₂SO₄ HCl, acetic acid, or phosphoric acid electrolyte). FIG. 1A shows cyclic voltammograms of a BBL anode, which exhibited two pairs of symmetric redox couples that corresponded to a two-step reaction associated with proton transfer during the redox process. Confirmed using in situ Raman spectroscopy below, the lower potential redox reaction at E_{1/2}=0.009 V vs. Ag/AgCl corresponds to (de) protonation of the imidazole ring, and the higher potential redox reaction at E_{1/2}=0.086 V corresponds to (de) protonation of the carbonyl group. The two redox couples displayed very small peak separations (ΔEₚ=27 mV and 5 mV, respectively, at 5 mV·s⁻¹) and only a slight increase in separation with scan rate, indicating the electrochemical reversibility of BBL. To understand the nature of the electrochemical reaction, the CV responses were analyzed according to the power law: iₚ=av^{b}, where a is an alterable parameter, and the b-value describes the reaction-diffusion behavior. Generally, a b-value of 0.5 suggests an ion diffusion-controlled (i.e., Faradaic) electrochemical process while a value of 1.0 indicates a non-diffusion controlled electrochemical process (i.e., non-Faradaic or capacitive behavior). Shown in FIG. 1B, the b-values of the two pairs of redox peaks for oxidation were 0.984 and 0.998, respectively, indicating a prominent pseudocapacitive behavior for proton transfer. Shown below, the pseudocapacitive charge storage mechanism promotes a relatively high-rate performance for the BBL electrode.

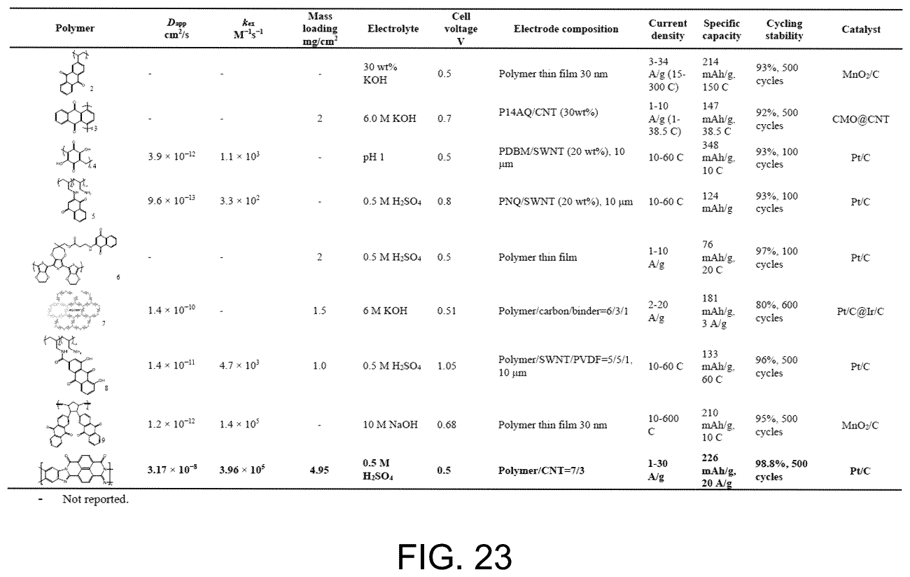

Also, relevant kinetic parameters including the apparent diffusion coefficient (Dₐₚₚ=3.17×10⁻⁸ cm²·s⁻¹), H⁺ diffusion coefficient (D_{H+}=1.40×10⁻⁸ cm²·s⁻¹), and self-exchanging reaction rate constant (Kₑₓ=3.96×10⁵ M⁻¹·s⁻¹) were quantified using the Randles-Sevcik equation and electrochemical impedance spectroscopy (EIS), (described in Example 3), showing a faster proton diffusivity in BBL than in other proton storage electrodes (10⁻¹³˜10⁻¹⁰ cm²·s⁻¹),³⁶ (FIG. 23).

To estimate the conductivity of BBL, in situ conductance measurements were used to monitor the conductance of the BBL film during cyclic voltammetry. FIG. 1C shows the response of BBL coated onto an interdigitated array electrode and the custom-built bi-potentiostat setup. The conductance, FIG. 1D, shows a Gaussian-shaped transfer curve^{37,38} during the reduction and oxidation process, in which a peak conductance close to 20 mS was observed at the corresponding peak potentials for the respective oxidation and reduction scans. This conductance corresponds to a BBL conductivity of about 3.81 S·cm⁻¹ when BBL is ˜50% doped, which is much higher than that of a quinone functionalized polythiophene (0.13 S·cm⁻¹) 23 or a conjugated microporous polymer (3.3×10⁻⁶ S·cm⁻¹) 24 used as anodes in polymer-air batteries elsewhere, as well as the conjugated polymer P(NDI2OD-T2) (5×10⁻³ S·cm⁻¹).³⁹ Such Gaussian-shaped transfer behavior, suitable electron affinity (4.15 eV),⁴⁰ as well as the rigid ladder-like structure enables the excellent reversibility, and allows BBL to attain a fast charge transport and high doping levels without any conformational disorder during the redox process.^{41,42} Taken together, the reversible proton transfer, fast kinetics, and high conductance of BBL confirms its feasibility as an anode for aqueous polymer-air batteries.

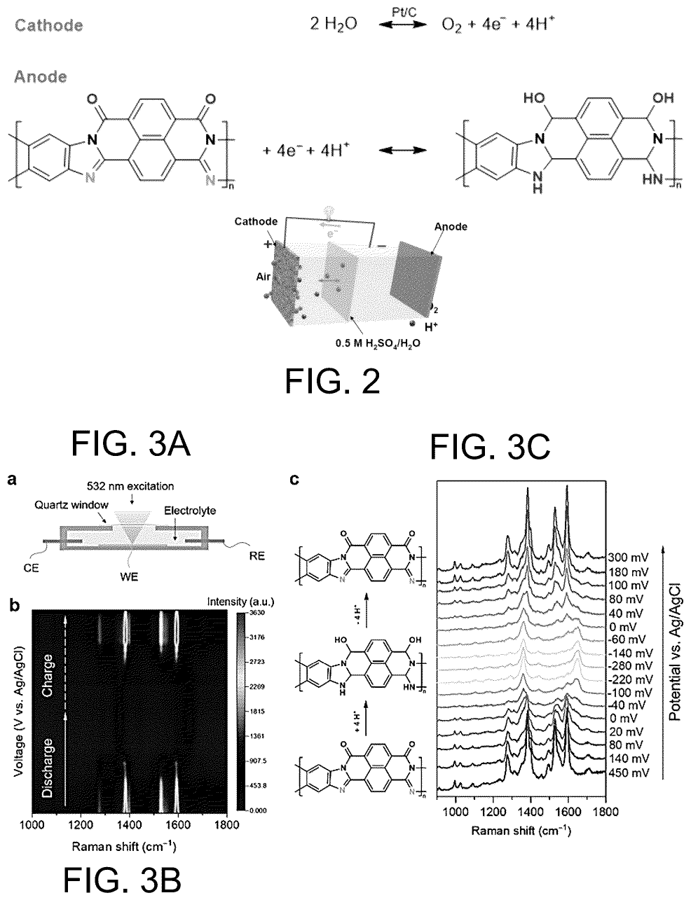

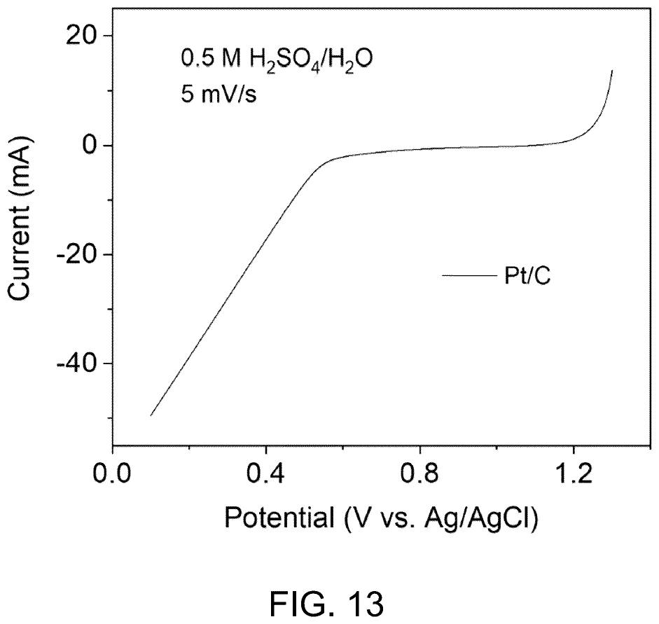

FIG. 2 shows the proposed redox mechanism of the BBL-air battery as well as a schematic of the acidic polymer-air battery. The BBL-air battery uses BBL as an anode, air as a cathode catalyzed by Pt/C, and H₂SO₄ electrolyte to allow for the flow of protons between the two electrodes. For charging on the cathode side, the OER occurs in which water (H₂O) is oxidized to produce oxygen gas (O₂), as well as four protons (H⁺) and four electrons (e⁻) (FIG. 13). For charging on the anode side, BBL is reduced and takes up protons at the carbonyl and imidazole rings as the redox-active sites, which involves four coupled protons and electrons. In discharge, the reverse reactions occur.

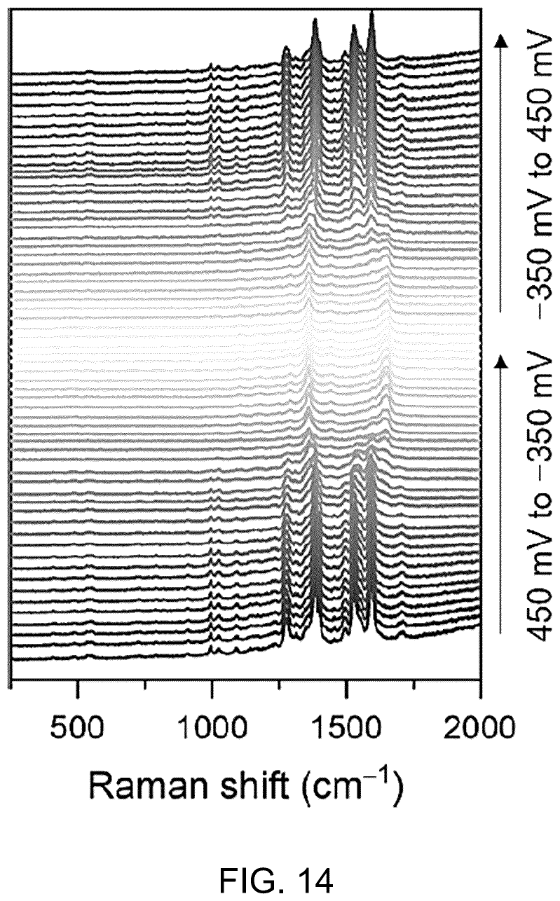

To verify the proposed redox mechanism, in situ Raman spectroscopy was performed to study the molecular and electronic structure evolution of BBL during charging and discharging, FIGS. 3A-3C. FIG. 3A shows the structure of the three-electrode cell for the in situ Raman measurement. The Raman spectra in the extended 250-2000 cm⁻¹ range are shown in FIG. 14. The 2D mapping of the Raman spectra confirms the reversibility of BBL's molecular structure changes during charging and discharging (FIG. 3B). To further understand the reversible molecular and electronic structural changes, the vibrational modes of the Raman spectra were analyzed at specific voltages (FIG. 3C). For un-protonated BBL, the following modes were assigned: symmetric C═O stretching at 1705 cm⁻¹, C═C/C—C breathing of the naphthalene ring at 1594 cm⁻¹, naphthalene ring breathing vibrations at 994 cm⁻¹, imidazole ring breathing vibrations at 1025 cm⁻¹, C—H bending vibrations at 1089, 1141, 1165, and 1230 cm⁻¹, and linear combinations of C—N and C—C stretching at 1529 cm⁻¹ and 1384 cm⁻¹.^{43.44} Upon discharge, the peaks gradually decreased in intensity, indicating changes in the electronic structure. As the potential decreased from 140 mV to −280 mV, the C═O peak shifted to slightly lower energies from 1705 cm⁻¹ to 1648 cm⁻¹, indicating protonation of the carbonyl group to generate C—OH, and the breathing vibration at 1025 cm⁻¹ decreased and the peak at 1384 cm⁻¹ shifted to 1360 cm⁻¹, which indicates protonation of the imidazole ring. Upon charging, the peaks reversibly recover, indicating a proton extraction process. Thus, in situ Raman spectroscopy confirms that C═O and C—N groups of the imidazole ring are redox-active sites for the BBL anode, with protonation of the carbonyl occurring first followed by protonation of the imidazole due to the higher electronegativity of oxygen vs nitrogen.

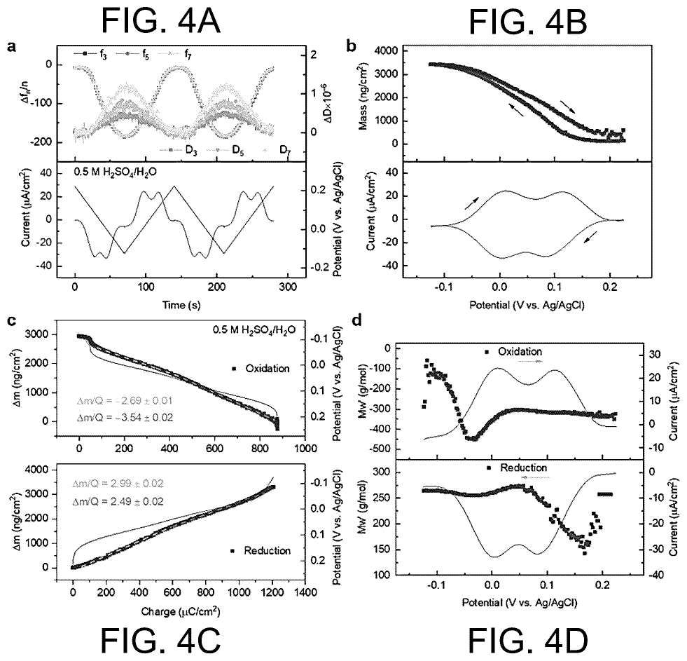

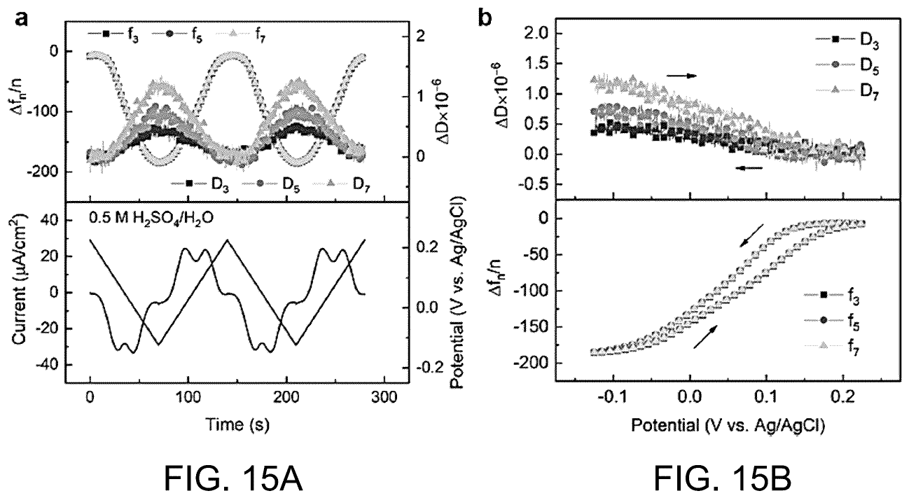

To understand the mass and charge transfer process and mechanism, electrochemical quartz crystal microbalance with dissipation (EQCM-D) was used to detect mass transfer and viscoelastic changes for a thin film of pure BBL (˜150 nm) during cyclic voltammetry. As shown in FIG. 4A, the frequency and dissipation responses track well with the corresponding cyclic voltammograms, in which step changes in both responses are correlated to the redox peaks of BBL. Besides, the small change in dissipation suggests only small volumetric changes for BBL during the redox process (swelling ratio ˜2.3%). The minimal swelling is likely a result of BBL's rigid conjugated ladder structure.⁴⁵ FIGS. 15A-15B show the frequency and dissipation responses for the cyclic voltammograms. Upon reduction, BBL electrodes exhibited two reduction peaks associated with protonation; at the same time, the frequency decreased, and the dissipation increased slightly. Upon oxidation, the reverse process occurred; specifically, the frequency increased upon de-protonation of the polymer. Overall, the frequency and dissipation changes were stable and reversible and tracked well with the BBL protonation/de-protonation process.

To understand the coupled mass and electron transfer process for the BBL electrode, EQCM-D data were treated using a Sauerbrey model, and the CV currents were integrated with time to obtain the mass and charge profiles, respectively. As shown in FIG. 4B, at the beginning of reduction, BBL mass remained relatively constant; then, while passing through the reduction reactions, the electrode mass significantly increased. Upon oxidation, the mass of the BBL electrode followed a similar reverse course. To further examine the coupling between the ionic and electronic charge transfer, the mass and charge profile were plotted together, as shown in FIG. 4C. The profiles were divided into two regions according to the two reduction reactions associated with (de) protonation in the cyclic voltammograms. The slopes of the two regions (in yellow and green) give an estimation of Δm/Q, or the mass transferred per each step in the redox process. Specifically, the experimental Δm/Q values for the BBL electrode with proton as the dopant were 2.99±0.02 and 2.49±0.02 mg·C⁻¹ for the first and second reduction reactions, respectively, and −2.69±0.01 and −3.54±0.02 mg·C⁻¹, for the first and second oxidation processes, respectively. Notably, these values are higher than the absolute theoretical value of 0.01 mg·C⁻¹ (per H+), which indicates that the redox process involves hydronium ion transport during the redox process instead (0.197 mg·C⁻¹) and additional water. To quantify the number of water molecules accompanying the hydronium ion during the redox process, the apparent molecular weight (Mw′=F×Δm/Q) of the transferred species for BBL was calculated based on the estimated Δm/Q values of each redox reaction. Specifically, the corresponding numbers of water molecules transported per hydronium ion were 6.96 and 5.62 for the first and second reduction reactions, respectively, and 6.18 and 8.46 for the first and second oxidation processes, respectively. These results confirm that at the level of the first hydration shell, more complex species, such as the Zundel cation (H₅O₂⁺) or the Eigen cation (H₉O₄⁺), are involved in the transport process.

To further understand the Mw′ change in more detail, the Mw′ of the transferred species during a complete CV scan was calculated from the mass and charge profile of the BBL electrode, resulting in FIG. 4D. At the beginning of the reduction, the Mw′ value was positive and decreased with decreasing potential, indicating a dehydration process (water is released from the electrode) before insertion into the polymer. Then the Mw′ rapidly became more positive with further decreasing potential; simultaneously hydronium ions and water were inserted into the polymer, and Mw′ finally leveled off. Upon oxidation, BBL displayed a reverse Mw′ behavior. The positive values of Mw′ during reduction and negative values of Mw′ during oxidation indicate that electroneutrality of the redox process is predominantly satisfied by hydronium/water transfer.

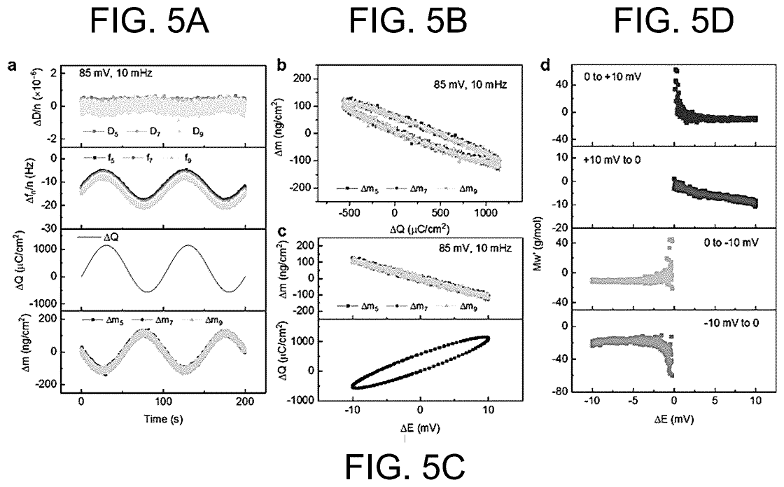

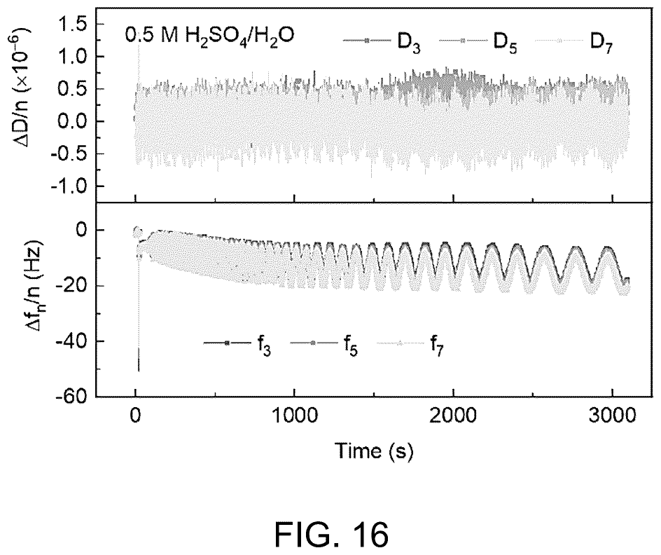

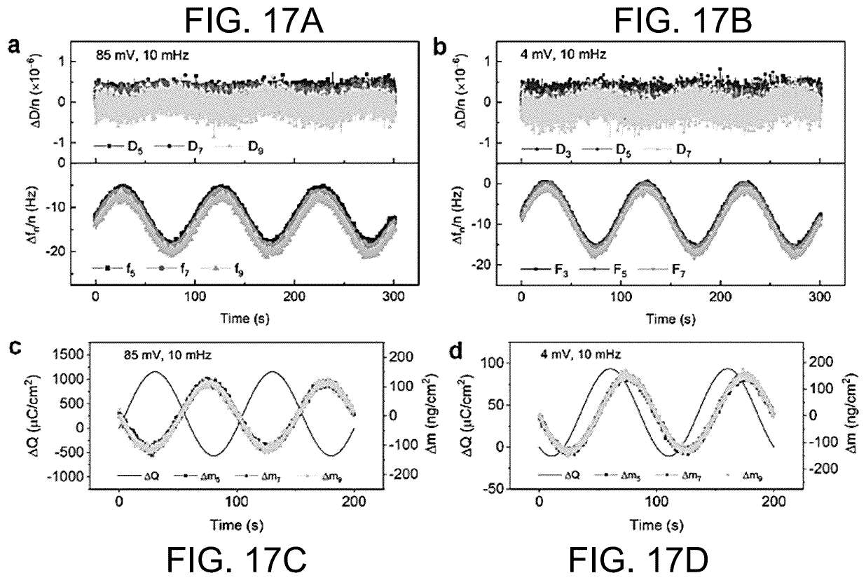

To further clarify the dynamic mass insertion/extraction process, in situ EQCM-D was employed with electrochemical impedance spectroscopy (EIS). A sinusoidal potential perturbation of 10 mV was applied to the BBL-coated quartz crystal, and the simultaneous frequency and dissipation responses were recorded. The DC voltage was set at 85 mV vs. Ag/AgCl, which corresponds to the peak current of the first reduction step (protonation of the carbonyl). As shown in FIG. 16, both frequency and dissipation exhibited sinusoidal patterns, and the amplitude increased with decreasing EIS frequency. To clarify the frequency-dependent responses of the transferred species, the oscillating current response, the charge transferred (ΔQ), and the mass change (Δm) were analyzed at a frequency of 10 mHz, FIGS. 5A-5D and FIGS. 15A-15D. The corresponding ΔQ and Δm responses of the transferred species exhibited sinusoidal profiles in the time domain and increased amplitudes at the frequency of 10 mHz, FIG. 5A. The plots of Δm vs ΔQ, and ΔQ and Δm vs ΔE have characteristic tilted oval shapes, corresponding to Lissajous plots that indicate the phase angle of the response, FIG. 5B, 5C. Comparing the ΔQ−Δm−ΔE responses allows one to qualitatively remark on whether cation or anion are transferring at a given EIS frequency, FIG. 5D. At 10 mHz, with increasing ΔE (0 to +10 mV, ¼ of the wave's period), BBLH₄ (protonated BBL) oxidized to BBL, ΔQ increases, and Δm decreases, this leads to a negative Mw′ value, indicating that hydronium transport is the dominating mechanism for charge compensation during the diffusion process. Similarly, the other ¾ of the wave's period also leads to a negative Mw′ value, indicating that hydronium ion transport is the dominating mechanism for charge compensation for the entire EIS cycle. This is because the mass of the hydronium ion is much less than that of the bulky SO₄⁻, so the cation presents a lower energy barrier for charge compensation.

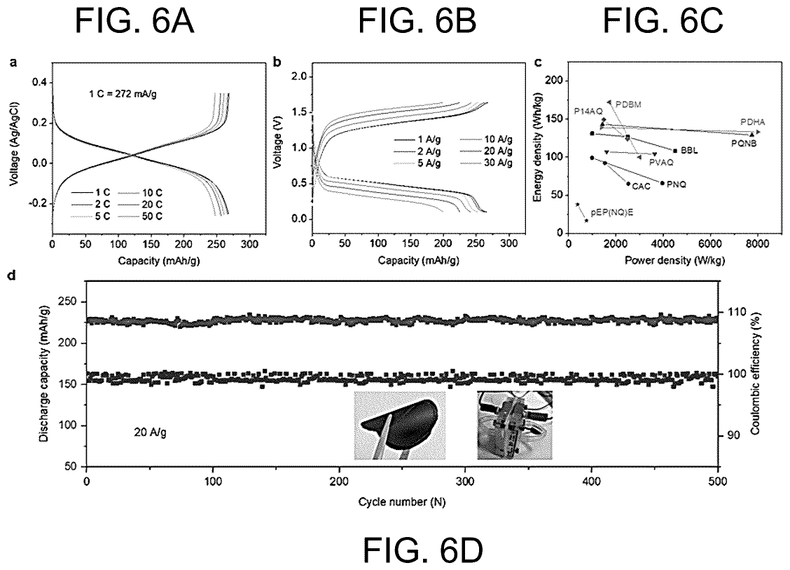

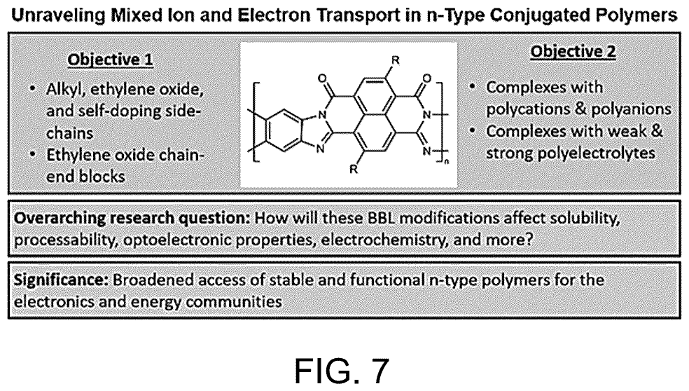

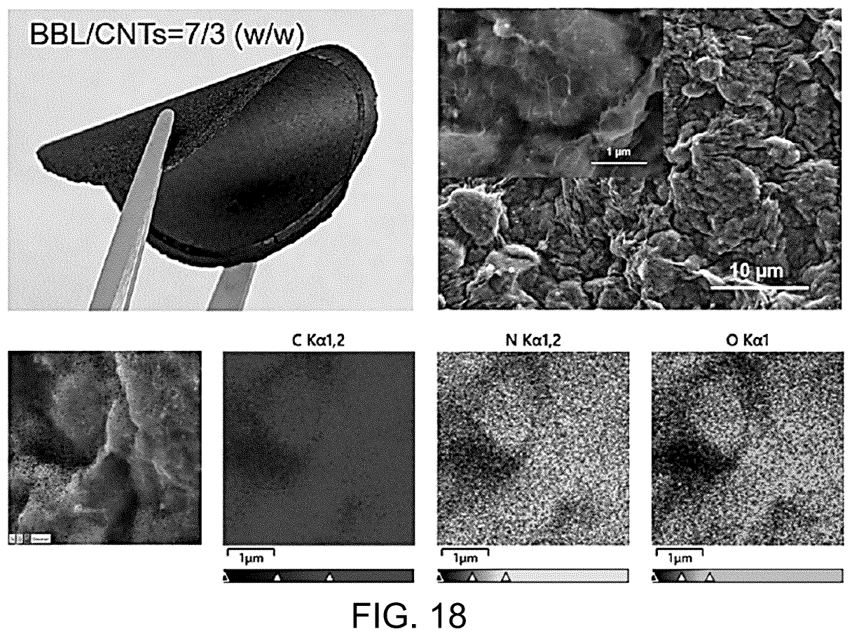

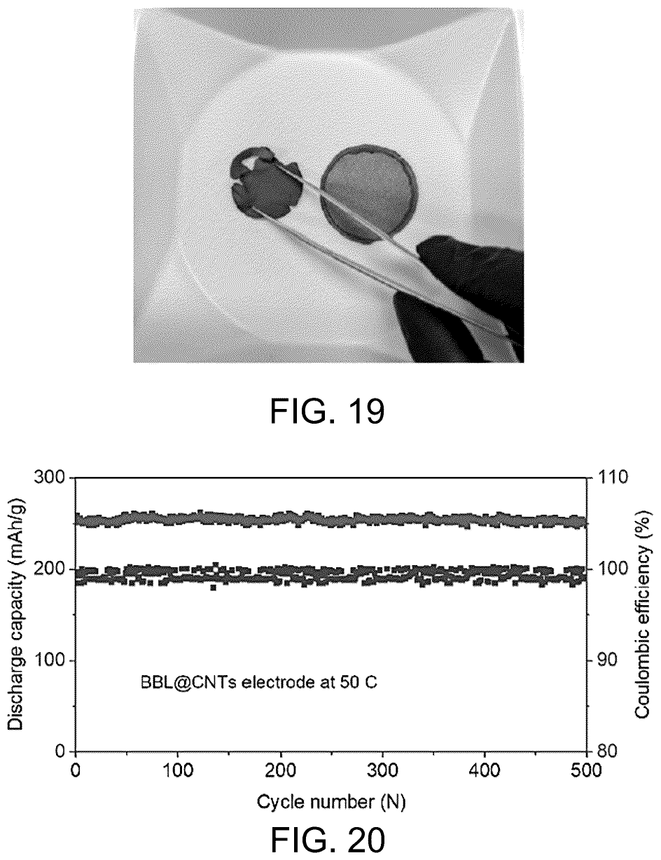

The electrochemical performance of the BBL-air battery was tested in air, as shown in FIGS. 6A-6D. To enhance the processability and strength of the BBL film, a BBL@CNTs composite flexible electrode was prepared by vacuum filtration (see Experimental Section for details). The morphologies of the BBL@CNTs composite electrode were observed using scanning electron microscopy (SEM), in which the CNTs formed a three-dimensional conducting network with BBL uniformly coated on the surface of the CNTs, FIGS. 18 and 19. The charge-discharge performance of the BBL@CNTs electrode was first evaluated in a three-electrode cell with Pt wire and Ag/AgCl as the counter and reference electrode, respectively. FIG. 6A shows the charge-discharge curves of the BBL@CNTs electrode at different current rates. At a current rate of 1 C (272 mA·g⁻¹), the BBL@CNTs electrode delivered a discharge capacity of 268 mAh·g⁻¹ based on the mass of BBL, which is close to 99% of the theoretical capacity (272 mAh·g⁻¹), indicating the high utilization and reversibility of the active sites in BBL. As the current rate increased from 1 C to 50 C, the polarization of the charge-discharge curves increased slightly; notably, even at a high current rate of 50 C, the deliverable capacity was as high as 249 mAh·g⁻¹ even after 500 cycles (99.7% capacity retention compared to the initial value), suggesting remarkable rate capability and cycling stability of the BBL@CNTs electrode, FIG. 20. The high stability of the BBL@CNTs electrode after long cycling at a high current is attributed to BBL's rigid conjugated ladder structure.

Finally, full BBL-air batteries were assembled with BBL@CNTs as the anode, air as the cathode catalyzed by Pt/C, and H₂SO₄ electrolyte to allow for the flow of protons between the two electrodes. At 1 A·g⁻¹, the charging and discharging curves of the cell exhibited a plateau voltage at 1.25 and 0.6 V, respectively, and delivered a capacity of 266 mAh·g⁻¹ with a coulombic efficiency near 100%, demonstrating reversible charge storage for the BBL-air battery, FIG. 6B. The voltages obtained by this battery corresponded to the potential of BBL against that of oxygen. As the current density increased to 30 A·g⁻¹, the capacity remained relatively high at 201 mAh·g⁻¹, suggesting an excellent rate capability. It is noted that the high polarization of the charge-discharge curve occurs likely due to the inherently sluggish ORR/OER kinetics on the cathode side.^{12,46} FIG. 6C shows the energy and power of reported polymer-air batteries. The BBL-air battery with a typical loading mass of 4.95 mg·cm⁻² displays a high specific energy and power compared to the other reported non-conjugated and conjugated microporous polymers, which either use thin-film electrodes (30 nm to 10 μm) or have a lower mass loading <2 mg·cm⁻², FIG. 23. The cycling stability of the BBL-air battery was assessed at 20 A·g⁻¹, yielding an initial discharge capacity of 226 mAh·g⁻¹ (83% theoretical capacity) and a capacity retention of 98.8% (compared to the initial value) after 500 cycles, indicating the notably long cycling stability of the BBL-air battery, FIG. 6D. These results confirm the significant rate capability and cycling stability of the BBL-air battery due to BBL's conjugated ladder structure and high electrical conductivity.

In conclusion, the conjugated ladder polymer BBL was examined as the anode for an aqueous polymer-air battery. The rigid ladder structure, reversible proton transfer, fast kinetics, and high electrical conductivity of BBL confirmed it's feasibility. The real-time charge transfer and diffusion mechanism was quantified using in situ EQCM-D, demonstrating that the hydronium ion dominated the charge compensation process. To improve the processability of the BBL active material, a self-standing BBL@CNTs electrode was prepared, which exhibited excellent rate capability (249 mAh·g⁻¹ at 50 C) and cycling stability (99.7% capacity retention compared to the initial value) after 500 cycles. The full BBL-air battery delivered a capacity of 201 mAh·g⁻¹ even at 30 A·g⁻¹ and cycled at 20 A·g⁻¹ with a capacity retention of 98.8% (compared to the initial value) after 500 charge-discharge cycles. The present disclosure highlights that conjugated ladder polymers are promising anodes for polymer-air batteries, which can require long-term stability, high conductivity, and fast kinetics.

### Experimental Section

### Materials

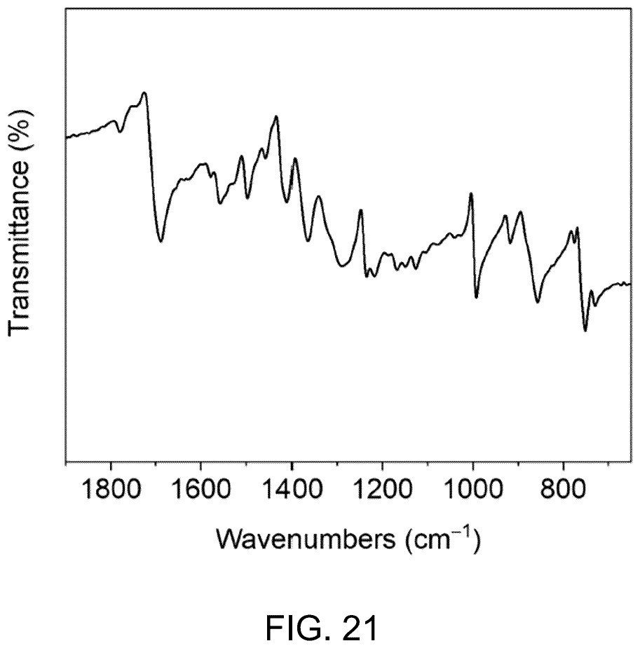

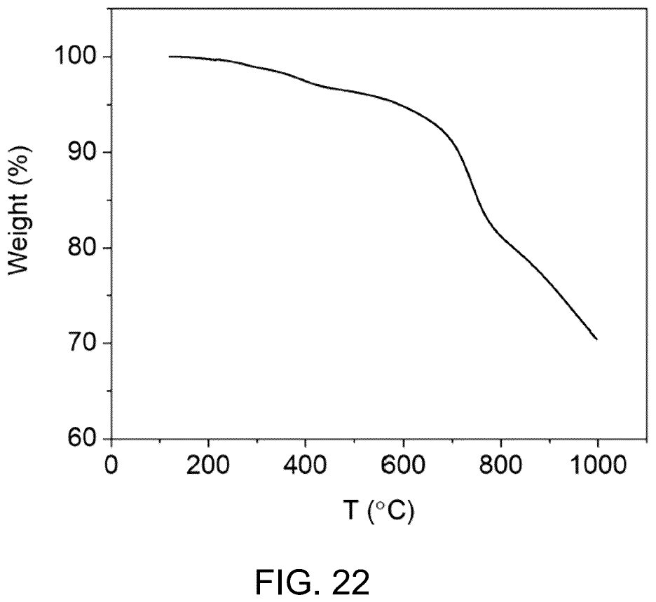

Sulfuric acid (H₂SO₄, 95.0-98.0%), methanesulfonic acid (MSA, >99%), commercial poly(benzimidazobenzophenanthroline) (BBL), and carbon nanotube (multi-walled, carboxylic acid functionalized) were purchased from Sigma-Aldrich and used as received. The Fourier-transform infrared spectra and thermogravimetric analysis of BBL can be seen in FIGS. 21 and 22.

### Electrochemical Kinetics

Electrochemical measurements were conducted using a three-electrode cell at room temperature. An Ag/AgCl (Sat. KCl) electrode and a Pt wire were used as reference and counter electrodes, respectively. BBL-coated glassy carbon was used as the working electrode to carry out cyclic voltammetry and electrochemical impedance spectroscopy experiments in argon-saturated 0.5 M H₂SO₄/H₂O electrolyte (5 mL). The working electrode was prepared by drop-casting BBL/MSA solution (10 mg·mL⁻¹, 20 μL) onto the surface of glassy carbon followed by neutralization with 10% triethylamine/ethanol, washing with mill-Q water, and vacuum drying. The typical areal loading was around 1.0˜1.1 mg·cm⁻². A Gamry Interface 1000 was employed for electrochemical measurements. The kinetic parameters (Dₐₚₚ, D_{H+}, k⁰) were calculated using the Randles-Sevcik equation, Nicholson method, and EIS measurements, see Example 3.

### EQCM-D

Multiharmonic quartz-crystal measurements using EQCM-D were completed using a Q-sensor analyzer (QE 401) equipped with an electrochemistry module (QEC 401 Electrochemistry Module). All QCM-D parts and sensors were purchased from Biolin Scientific. Au/Ti-coated AT-cut quartz crystals with a fundamental resonance frequency of 4.95 MHz were used as the substrate. The sensor preparation and operating procedures are described in a previous study.⁴⁷ BBL thin film (˜150 nm) was spun cast (1000 rpm for 60 s followed by 1500 rpm for 60 s) over the sensor from an MSA solution (5 mg·mL⁻¹, 100 μL). The polymer-coated sensor was washed with 10% triethylamine/ethanol followed by mill-Q water and then vacuum dried at 80° C. overnight before use. The measurements were obtained using a Gamry Interface 1000 connected to the flow chamber with a three-electrode setup (Ag/AgCl as the reference electrode, Pt plate as the counter electrode, and BBL-coated gold sensor as the working electrode). For in situ CV-QCM-D, the applied potential range was from −0.125 to 0.225 V vs Ag/AgCl at 5 mV·s⁻¹. For in situ EIS-QCM-D, a sinusoidal potential perturbation (10 mV) was applied to the BBL-coated quartz crystal, and the simultaneous frequency and dissipation responses were recorded. The EIS frequency range was 10⁷ Hz˜5 mHz. The DC voltage was the reduction peak potential (˜85 mV vs Ag/AgCl) of the BBL electrode. In all cases, the tests proceeded at room temperature. Data acquisition was performed using QSoft401 software. The Sauerbery equation was used to model the raw QCM-D data for the CV and EIS process due to the small changes in dissipation.⁴⁸ The charge transferred during the AC period was calculated by integrating the current with respect to time. Detailed data analysis and calculations can be found in the previous study.⁴⁹

### In-Situ Conductance

For in-situ conductance measurements, a thin film gold InterDigitated Electrode (IDE) with 90 pairs of Au bands on a glass substrate (10/10 μm, 3.5 mm Ø, electrode/gap, Micrux Technologies, Spain) was used. A potential bias of 10 mV was applied. The conductance and conductivity were calculated as previously reported.⁵⁰

### In Situ Raman Spectroelectrochemistry

In situ Raman spectroscopy was conducted in combination with a three-electrode electrochemical cell (GaossUnion Photoelectric Technology Company) with BBL@CNTs as the working electrode, carbon rod as the counter electrode, and Ag/AgCl as the reference electrode in 0.5 M H₂SO₄/H₂O. The Raman spectra were collected using a Renishaw in Via Qontor microscope equipped with a 532 nm laser during the charge-discharge process of the three-electrode cell connected to the potentiostat (Metrohm AutoLab PGSTAT302N).

### BBL@CNTs Electrode Preparation and BBL-Air Battery Assembly and Testing

The BBL-air battery was assembled with a BBL@CNTs anode, a Pt/C supported on the carbon cloth as the air cathode, 0.5 M H₂SO₄/H₂O electrolyte, and a glass fiber separator. The BBL@CNTs self-standing electrode was prepared by vacuum filtration the dispersion of BBL and carbon nanotubes in a mass ratio of 7:3. To obtain the BBL dispersion, 35 mg BBL was dissolved in 350 mL MSA by ultrasonication. Then, the BBL/MSA solution was added dropwise into 1 L CNTs/ethanol (15 mg·L⁻¹) dispersion under rapidly stirring. The BBL@CNTs suspension was vacuum filtered and washed with ethanol and mill-Q water to obtain the BBL@CNTs film (ϕ=3 cm, thickness=0.21˜0.24 mm) and then vacuum dried at 80° C. overnight before use. The BBL mass loading of BBL@CNTs was around 4.95 mg·cm⁻². The air cathode was prepared by spraying a homogenous catalyst ink onto the hydrophilic side of a carbon cloth and then dried at 100° C. for 3 h with a typical Pt/C loading around 2 mg Pt/cm².⁵¹ The catalyst ink was made of 20 mg Pt/C (60% Pt loading), 10 mg Nafion ionomer, and 2970 mg isopropyl alcohol/H₂O (3/1 v/v) sonicated for 5 min with a tip-sonicator (125 W, 35% amplitude, Qsonica) to form a uniform dispersion (1 wt %). The carbon cloth was weighed before and after air-spraying to determine the catalyst loading. An Arbin battery-testing instrument was applied for the galvanostatic charge/discharge test with a potential range of 0.2-1.6 V at different current densities. The capacity of the cell was calculated based on the mass of BBL.

### EXAMPLE 1—REFERENCES

1. Li, Y. and Lu, J. (2017). Metal-Air Batteries: Will They Be the Future Electrochemical Energy Storage Device of Choice? ACS Energy Letters 2, 1370-1377, doi:10.1021/acsenergylett.7b00119.
2. Wang, H.-F. and Xu, Q. (2019). Materials Design for Rechargeable Metal-Air Batteries. Matter 1, 565-595, doi:10.1016/j.matt.2019.05.008.
3. Cheng, F. and Chen, J. (2012). Metal-air batteries: from oxygen reduction electrochemistry to cathode catalysts. Chem Soc Rev 41, 2172-2192, doi:10.1039/c1cs15228a.
4. Chen, Y., Xu, J., He, P., Qiao, Y., Guo, S., Yang, H., and Zhou, H. (2022). Metal-air batteries: progress and perspective. Sci Bull (Beijing) 67, 2449-2486, doi:10.1016/j.scib.2022.11.027.
5. Liu, Q., Pan, Z., Wang, E., An, L., and Sun, G. (2020). Aqueous metal-air batteries: Fundamentals and applications. Energy Storage Materials 27, 478-505, doi:10.1016/j.ensm.2019.12.011.
6. Liang, Y. and Yao, Y. (2022). Designing modern aqueous batteries. Nature Reviews Materials 8, 109-122, doi:10.1038/s41578-022-00511-3.
7. Huang, M., Wang, X., Liu, X., and Mai, L. (2022). Fast Ionic Storage in Aqueous Rechargeable Batteries: From Fundamentals to Applications. Adv Mater 34, e2105611, doi:10.1002/adma.202105611.
8. Yang, Q., Li, Q., Liu, Z., Wang, D., Guo, Y., Li, X., Tang, Y., Li, H., Dong, B., and Zhi, C. (2020). Dendrites in Zn-Based Batteries. Adv Mater 32, e2001854, doi:10.1002/adma.202001854.
9. Zhao, Z., Fan, X., Ding, J., Hu, W., Zhong, C., and Lu, J. (2019). Challenges in Zinc Electrodes for Alkaline Zinc-Air Batteries: Obstacles to Commercialization. ACS Energy Letters 4, 2259-2270, doi:10.1021/acsenergylett.9b01541.
10. Wang, L., Snihirova, D., Deng, M., Vaghefinazari, B., Xu, W., Höche, D., Lamaka, S. V., and Zheludkevich, M. L. (2022). Sustainable aqueous metal-air batteries: An insight into electrolyte system. Energy Storage Materials 52, 573-597, doi:10.1016/j.ensm.2022.08.032.
11. Salado, M. and Lizundia, E. (2022). Advances, challenges, and environmental impacts in metal-air battery electrolytes. Materials Today Energy 28, doi:10.1016/j.mtener.2022.101064.
12. Sun, W., Wang, F., Zhang, B., Zhang, M., Küpers, V., Ji, X., . . . & Winter, M. (2021). A rechargeable zinc-air battery based on zinc peroxide chemistry. Science 371, 46-51.
13. Zhang, F., Zhang, W., Wexler, D., and Guo, Z. (2022). Recent Progress and Future Advances on Aqueous Monovalent-Ion Batteries towards Safe and High-Power Energy Storage. Adv Mater 34, e2107965, doi:10.1002/adma.202107965.
14. Rohland, P., Schröter, E., Nolte, O., Newkome, G. R., Hager, M. D., and Schubert, U. S. (2022). Redox-active polymers: The magic key towards energy storage—a polymer design guideline progress in polymer science. Progress in Polymer Science 125, doi:10.1016/j.progpolymsci.2021.101474.
15. Goujon, N., Casado, N., Patil, N., Marcilla, R., and Mecerreyes, D. (2021). Organic batteries based on just redox polymers. Progress in Polymer Science 122, doi:10.1016/j.progpolymsci.2021.101449.
16. Nishide, H. (2022). Organic redox polymers as electrochemical energy materials. Green Chemistry.
17. Choi, W., Harada, D., Oyaizu, K., and Nishide, H. (2011). Aqueous electrochemistry of poly(vinylanthraquinone) for anode-active materials in high-density and rechargeable polymer/air batteries. J Am Chem Soc 133, 19839-19843, doi:10.1021/ja206961t.
18. Kawai, T., Oyaizu, K., and Nishide, H. (2015). High-Density and Robust Charge Storage with Poly(anthraquinone-substituted norbornene) for Organic Electrode-Active Materials in Polymer-Air Secondary Batteries. Macromolecules 48, 2429-2434, doi:10.1021/ma502396r.
19. Li, Y., Liu, L., Liu, C., Lu, Y., Shi, R., Li, F., and Chen, J. (2019). Rechargeable Aqueous Polymer-Air Batteries Based on Polyanthraquinone Anode. Chem 5, 2159-2170, doi:10.1016/j.chempr.2019.06.001.
20. Oka, K., Furukawa, S., Murao, S., Oka, T., Nishide, H., and Oyaizu, K. (2020). Poly(dihydroxybenzoquinone): its high-density and robust charge storage capability in rechargeable acidic polymer-air batteries. Chem Commun (Camb) 56, 4055-4058, doi:10.1039/d0cc00660b.
21. Oka, K., Murao, S., Kataoka, M., Nishide, H., and Oyaizu, K. (2021). Hydrophilic Anthraquinone-Substituted Polymer: Its Environmentally Friendly Preparation and Efficient Charge/Proton-Storage Capability for Polymer-Air Secondary Batteries. Macromolecules 54, 4854-4859, doi:10.1021/acs.macromol.1c00865.
22. Oka, K., Murao, S., Kobayashi, K., Nishide, H., and Oyaizu, K. (2020). Charge- and Proton-Storage Capability of Naphthoquinone-Substituted Poly(allylamine) as Electrode-Active Material for Polymer-Air Secondary Batteries. ACS Applied Energy Materials 3, 12019-12024, doi:10.1021/acsaem.0c02178.
23. Oka, K., Strietzel, C., Emanuelsson, R., Nishide, H., Oyaizu, K., Stromme, M., and Sjodin, M. (2020). Conducting Redox Polymer as a Robust Organic Electrode-Active Material in Acidic Aqueous Electrolyte towards Polymer-Air Secondary Batteries. ChemSusChem 13, 2280-2285, doi:10.1002/cssc.202000627.
24. Zhong, L., Fang, Z., Shu, C., Mo, C., Chen, X., and Yu, D. (2021). Redox Donor-Acceptor Conjugated Microporous Polymers as Ultralong-Lived Organic Anodes for Rechargeable Air Batteries. Angew Chem Int Ed Engl 60, 10164-10171, doi:10.1002/anie.202016746.
25. Facchetti, A. (2007). Semiconductors for organic transistors. Materials Today 10, 28-37, doi:10.1016/s1369-7021 (07) 70017-2.
26. Alam, M. M. and Jenekhe, S. A. (2004). Efficient Solar Cells from Layered Nanostructures of Donor and Acceptor Conjugated Polymers. Chemistry of Materials 16, 4647-4656, doi:10.1021/cm0497069.
27. Wilbourn, K. and Murray, R. W. (1988). The electrochemical doping reactions of the conducting ladder polymer benzimidazobenzophenanthroline (BBL). Macromolecules 21, 89-96, doi:10.1021/ma00179a019.
28. Roberts, M. F. and Jenekhe, S. A. (1994). Lewis acid coordination complexes of polymers: 3. Poly(benzobisimidazobenzophenanthroline) ladder and semiladder polymers. Polymer 35, 4313-4325, doi:https://doi.org/10.1016/0032-3861 (94) 90088-4.
29. Chen, X. L., Bao, Z., Schön, J. H., Lovinger, A. J., Lin, Y.-Y., Crone, B., Dodabalapur, A., and Batlogg, B. (2001). Ion-modulated ambipolar electrical conduction in thin-film transistors based on amorphous conjugated polymers. Applied Physics Letters 78, 228-230, doi:10.1063/1.1339849.
30. Babel, A. and Jenekhe, S. A. (2003). High Electron Mobility in Ladder Polymer Field-Effect Transistors. Journal of the American Chemical Society 125, 13656-13657, doi:10.1021/ja0371810.
31. Sun, H., Vagin, M., Wang, S., Crispin, X., Forchheimer, R., Berggren, M., and Fabiano, S. (2018). Complementary Logic Circuits Based on High-Performance n-Type Organic Electrochemical Transistors. Advanced Materials 30, 1704916, doi:https://doi.org/10.1002/adma.201704916.
32. Yang, C. Y., Stoeckel, M. A., Ruoko, T. P., Wu, H. Y., Liu, X., Kolhe, N. B., Wu, Z., Puttisong, Y., Musumeci, C., Massetti, M. et al. (2021). A high-conductivity n-type polymeric ink for printed electronics. Nat Commun 12, 2354, doi:10.1038/s41467-021-22528-y.
33. Cruz-Arzon, A. J., Serrano-Garcia, W., Pinto, N. J., Gupta, N., and Johnson, A. T. C. (2022). Temperature dependent charge transport in electrostatically doped poly[benzimidazobenzophenanthroline] thin films. Journal of Applied Polymer Science 140, doi:10.1002/app.53470.
34. Wu, J., Rui, X., Wang, C., Pei, W.-B., Lau, R., Yan, Q., and Zhang, Q. (2015). Nanostructured Conjugated Ladder Polymers for Stable and Fast Lithium Storage Anodes with High-Capacity. Advanced Energy Materials 5, 1402189, doi:https://doi.org/10.1002/aenm.201402189.
35. Wilbourn, K., and Royce W. Murray. (1988). The electrochemical doping reactions of the conducting ladder polymer benzimidazobenzophenanthroline (BBL). Macromolecules 21, 89-96.
36. Su, Z., Tang, J., Chen, J., Guo, H., Wu, S., Yin, S., Zhao, T., Jia, C., Meyer, Q., Rawal, A. et al. (2023). Co-insertion of Water with Protons into Organic Electrodes Enables High-Rate and High-Capacity Proton Batteries. Small Structures, doi:10.1002/sstr.202200257.
37. Jariwala, D., Sangwan, V. K., Wu, C. C., Prabhumirashi, P. L., Geier, M. L., Marks, T. J., Lauhon, L. J., and Hersam, M. C. (2013). Gate-tunable carbon nanotube-MoS2 heterojunction p-n diode. Proc Natl Acad Sci USA 110, 18076-18080, doi:10.1073/pnas.1317226110.
38. Wakayama, Y. and Hayakawa, R. (2019). Antiambipolar Transistor: A Newcomer for Future Flexible Electronics. Advanced Functional Materials 30, doi:10.1002/adfm.201903724.
39. Wang, S., Sun, H., Ail, U., Vagin, M., Persson, P. O., Andreasen, J. W., Thiel, W., Berggren, M., Crispin, X., Fazzi, D. et al. (2016). Thermoelectric Properties of Solution-Processed n-Doped Ladder-Type Conducting Polymers. Adv Mater 28, 10764-10771, doi:10.1002/adma.201603731.
40. Xu, K., Sun, H., Ruoko, T. P., Wang, G., Kroon, R., Kolhe, N. B., Puttisong, Y., Liu, X., Fazzi, D., Shibata, K. et al. (2020). Ground-state electron transfer in all-polymer donor-acceptor heterojunctions. Nat Mater 19, 738-744, doi:10.1038/s41563-020-0618-7.
41. Fazzi, D. and Negri, F. (2020). Addressing the Elusive Polaronic Nature of Multiple Redox States in a TT-Conjugated Ladder-Type Polymer. Advanced Electronic Materials 7, doi:10.1002/aelm.202000786.
42. Harikesh, P. C., Yang, C. Y., Wu, H. Y., Zhang, S., Donahue, M. J., Caravaca, A. S., Huang, J. D., Olofsson, P. S., Berggren, M., Tu, D. et al. (2023). Ion-tunable antiambipolarity in mixed ion-electron conducting polymers enables biorealistic organic electrochemical neurons. Nat Mater 22, 242-248, doi:10.1038/s41563-022-01450-8.
43. Xu, K., Ruoko, T. P., Shokrani, M., Scheunemann, D., Abdalla, H., Sun, H., Yang, C. Y., Puttisong, Y., Kolhe, N. B., Figueroa, J. S. M. et al. (2022). On the Origin of Seebeck Coefficient Inversion in Highly Doped Conducting Polymers. Advanced Functional Materials 32, doi:10.1002/adfm.202112276.
44. Teketel Yohannes, H. N., Silvia Luzzati, Marinella Catellani, Samson A. Jenekhe, and N. Serdar Sariciftci. (2000). Multiple Electrochemical Doping-Induced Insulator-to-Conductor Transitions Observed in the Conjugated Ladder Polymer Polybenzimidazobenzophenanthroline (BBL). J. Phys. Chem. B 104, 9430-9437.
45. Guo, J., Flagg, L. Q., Tran, D. K., Chen, S. E., Li, R., Kolhe, N. B., Giridharagopal, R., Jenekhe, S. A., Richter, L. J., and Ginger, D. S. (2023). Hydration of a Side-Chain-Free n-Type Semiconducting Ladder Polymer Driven by Electrochemical Doping. J Am Chem Soc 145, 1866-1876, doi:10.1021/jacs.2c11468.
46. Li, L. and Manthiram, A. (2016). Long-Life, High-Voltage Acidic Zn-Air Batteries. Advanced Energy Materials 6, doi:10.1002/aenm.201502054.
47. Ma, T., Easley, A. D., Wang, S., Flouda, P., and Lutkenhaus, J. L. (2021). Mixed electron-ion-water transfer in macromolecular radicals for metal-free aqueous batteries. Cell Reports Physical Science 2, doi:10.1016/j.xcrp.2021.100414.
48. Easley, A. D., Ma, T., Eneh, C. I., Yun, J., Thakur, R. M., and Lutkenhaus, J. L. (2021). A practical guide to quartz crystal microbalance with dissipation monitoring of thin polymer films. Journal of Polymer Science 60, 1090-1107, doi:10.1002/pol.20210324.
49. Ma, T., Li, C. H., Thakur, R. M., Tabor, D. P., and Lutkenhaus, J. L. (2023). The role of the electrolyte in non-conjugated radical polymers for metal-free aqueous energy storage electrodes. Nat Mater 22, 495-502, doi:10.1038/s41563-023-01518-z.
50. Karlsson, C., Huang, H., Strømme, M., Gogoll, A., and Sjödin, M. (2015). Ion- and Electron Transport in Pyrrole/Quinone Conducting Redox Polymers Investigated by In Situ Conductivity Methods. Electrochimica Acta 179, 336-342, doi:10.1016/j.electacta.2015.02.193.
51. Yang, Y., Tocchetto, R., Nixon, K., Sun, R., and Elabd, Y. A. (2022). Dehumidification via polymer electrolyte membrane electrolysis with sulfonated pentablock terpolymer. Journal of Membrane Science 658, doi:10.1016/j.memsci.2022.120709.

### Example 2

### Introduction

Conjugated polymers are essential to organic electronics, energy storage, and sensing. A key feature of conjugated polymers' functionality is that they conduct ions and electrons simultaneously during device operation.^{1.5} For example, organic electrochemical transistors (OECTs)—a powerful platform for bioelectronics, neuromorphic devices, and biosensors—operate by the electrochemical reduction or oxidation of the conjugated polymer to switch between conductive and insulating states.^{1, 6-10} This switching process requires not only the transfer or electrons but also ions. Compared with well-established p-type OECT materials, n-type OECT materials are less-established as they are often unstable to air and moisture and because they possess lower mobility or conductivity. For example, n-type p (gNDI-g2T) possesses comparatively low mobility and also instability in the reduced state.^{1, 11} Here, our long-term goal is to establish a fundamental understanding of the redox mechanisms of n-type polymers in the context of mixed ion and electron conduction with reversible electrochemical switching.

Recently, ladder-type poly(benzimidazobenzophenantroline) (BBL) has emerged as an efficient and stable n-type polymer for OECTs.¹² BBL has a highly planar and rigid π-conjugated backbone^{13, 14} which facilitates intramolecular transfer, leading to high charge mobility (0.1 cm² V⁻¹ s⁻¹)^{15, 16} and electronic conductivity 8 S cm⁻¹ (in a complex).^{17, 18} However, BBL is notably hard to chemically modify post-synthesis and to process because of its ladder-type structure and general intractability.¹⁹ Prior work with conjugated polymers shows that modifying the main chain with side chains can lead to improvements in processability and electronic properties.²⁰⁻²⁶ However, with limited ability to derivatize BBL, a comprehensive understanding of how side-chains and other modifications improve BBL's electrochemistry and mixed conduction is lacking.

Complexation with polyelectrolytes is another promising approach to modulate BBL's properties while enhancing solubility. BBL complexes with poly(styrenesulfonate) (PSS),²⁷ poly(ethyleneimine),¹⁷ and poly(3-(2-(2-(2-(thiophen-3-yloxy) ethoxy) ethoxy) ethoxy) propanoate)-2,5-thiophene-diyl) 28 showed improved stability and electrical conductivity. Similar beneficial effects are seen in conductive polymer complexes including poly(3,4-ethylenedioxythiophene):PSS (PEDOT:PSS)²⁹⁻³¹ and polyaniline:poly(2-acrylamido-2-methyl-1-propanesulfonic acid) (PANI:PAAMPSA),³²⁻³⁵ with key work on PANI:PAAMPSA also completed.³⁶⁻³⁸ Reversible complexes of BBL with Lewis acids can promote solubility but may require selective removal of the donor.³⁹ With few reports of BBL: polyelectrolyte complexes,^{17, 27, 28, 39} there is little known regarding their electrochemistry and mixed conduction.

Here, the research questions to be explored are the following: how do 1) side-chain or chain-end groups and 2) polyelectrolyte complexation influence BBL's electrochemistry, conductivity, and switching behavior, along with morphology and swelling at various levels of doping. Based on this, two Objectives were proposed, focused upon synthesizing and characterizing new BBL derivatives, targeting a long-term goal of broadening understanding of n-type polymers for wider impact on OECT applications.

### Objective 1: Understand Side-Chain and Chain-End Effects in BBL Derivatives

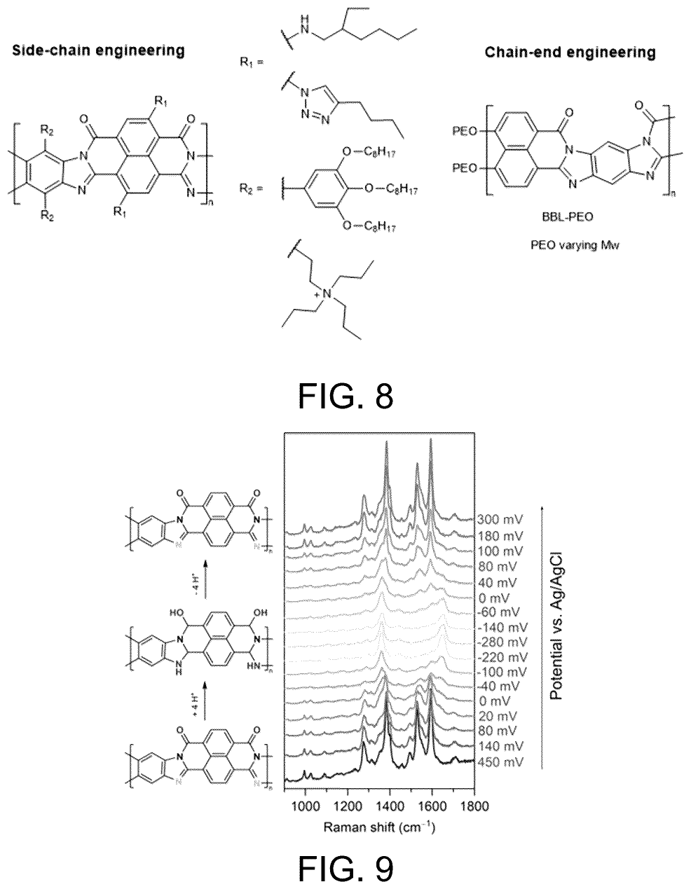

In this objective, a collection of BBL derivatives were synthesized with alkyl, ethylene oxide, alkylamine, and charged side-chains or ethylene oxide chain-ends for comparison against side-chain-free BBL. FIG. 8 shows a collection of BBL derivatives synthesized. BBL has been synthesized by the method described by Arnold and Van Deusen.^{40,41} BBL-PEOs has been prepared by an esterification reaction of BBL with poly(ethylene glycol) methyl ether of varying molar masses (550-5000 g mol⁻¹) with the purpose of controlling chain end block lengths.⁴² Following the description of Hirvonen et al.,⁴³ 1,4,5,8-naphthalenetetracarboxylic acid monomer has been brominated, which can be replaced directly with 2-ethyl-1-hexylamine or an azide. The azide was used in a click-reaction to introduce an alkyl triazole side chain. Then, the corresponding BBL derivatives have been obtained by polycondensation of the modified monomer. The synthetic strategy of alkoxy and quaternary ammonium cations modified BBL involves the use of naphthalene double-stranded heterocyclic tetraamine as the building blocks with introduction at the lateral positions, followed by polycondensation of the tetraamine monomers with aromatic dianhydride monomer in m-cresol at elevated temperature.^{44, 45}

This provided an understanding of how charge transfer kinetics and mixed conduction are influenced by different side-chains or end-chains. BBL derivatives has been analyzed using NMR and FTIR spectroscopy, thermal analysis, and viscometry to verify synthesis as well as thermophysical properties. UV-vis spectroscopy, X-ray scattering, electrochemistry, and atomic force microscopy provided estimates of the optical band gap, LUMO level, and morphology.^{46, 47} Doping-dependent conductivity using standard dopants from literature^{48, 49} was quantified using four-point probe measurements of spin-cast BBL derivatives.

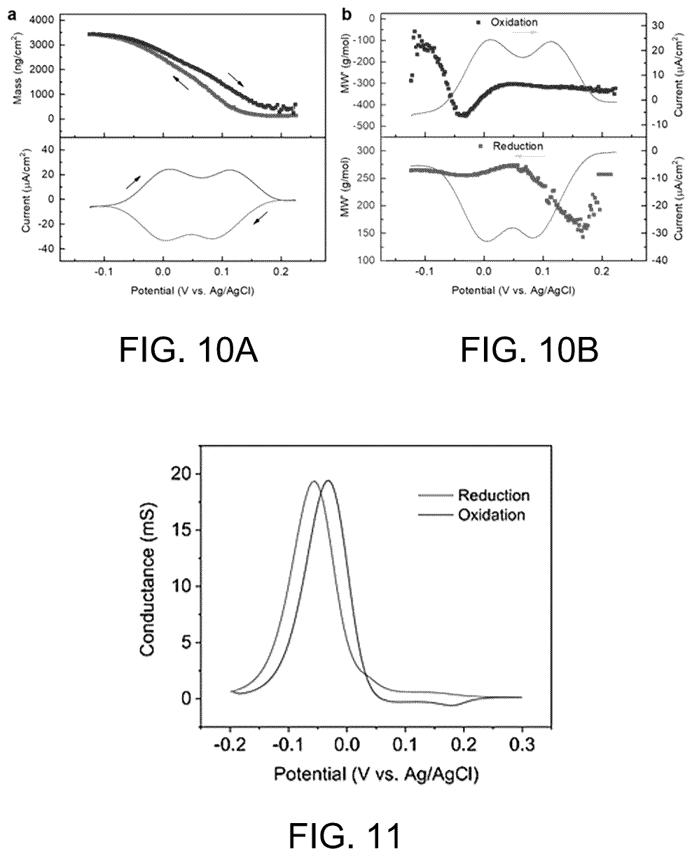

Besides ex situ measurements, three signature in situ measurements were conducted that allow understanding of how state of charge or doping level affects chemical structure, swelling, and ion transfer. In situ Raman spectroscopy revealed changes in bonding environments during electrochemical cycling to understand how side-chains, especially self-doping chains, alter the redox mechanism relative to bare BBL's protonation of carbonyl and imidazole groups. The data shows one such example for bare BBL, FIG. 9, which confirmed that C═O and C—N of groups of the imidazole ring were redox-active sites of the BBL electrode.⁵⁰ In situ electrochemical quartz crystal microbalance (EQCMD) enabled separation of electron and ion transfer processes by measuring real-time mass changes associated with influx and efflux of ions during cycling. Using EQCMD on bare BBL in an acidic electrolyte, FIGS. 10A-B, the BBL electrode's mass increased upon reduction due to the uptake of protons and water molecules, with the number of transferred water molecules quantified by comparing effective molecular weight (Mw′) of the transferring species vs that predicted by Faraday's law.⁵⁰ EQCMD was applied to decouple ion and solvent transport for redox active polymers containing stable nitroxide radical groups,⁵¹⁻⁵⁶ poly(3-hexyl thiophene),⁵⁷ and BBL.⁵⁰ Last, operando conductance measurements made using specialized instrumentation directly revealed connections between the electrochemical state of BBL derivatives during voltammetry and their electronic properties including conductivity.⁵⁰ Specifically, BBL derivatives were coated onto an interdigitated array electrode and characterized in a bipotentiostat configuration, FIG. 11.

The nature of the side-chain or chain-end reveals different effects on the mixed conduction behavior. Ethylene oxide side chains may facilitate ion transport, while self-doping side chains may change the redox potential. Alkyl chains may change the switching speed by allowing for enhanced electrolyte uptake, much like ethylene oxide side chains. Chain-end vs side-chain functionalization may lead to different electrode morphologies with drastically different mixed conduction behavior. For example, the side-chains may disrupt TT-TT stacking of the BBL units, perhaps leading to changes in the band gap due to electron withdrawing/donating effects.

Objective 2: Complexation of BBL with Polycations and Polyanions

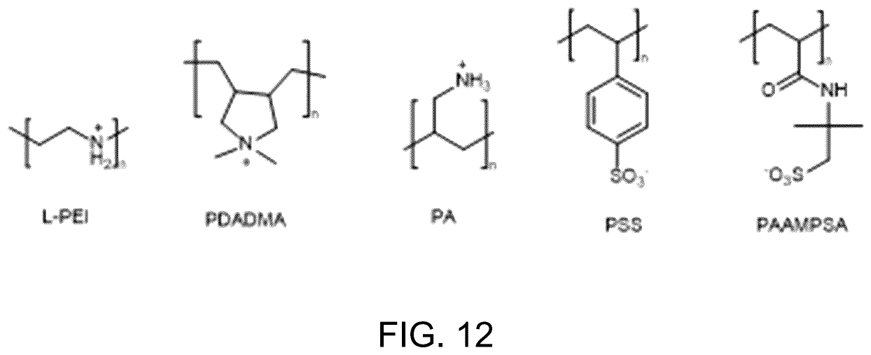

In this objective, BBL was synthesized with polyelectrolytes to create complexes, shown in FIG. 12. Polycations of interest include linear polyethylene imine (L-PEI), poly(diallyldimethylammonium) (PDADMA), and poly(allylamine) (PA); polyanions of interest include PSS and PAAMPSA. Weak polyelectrolytes like L-PEI and PA acted as proton sources to dope BBL in aqueous conditions due to their pH-dependent charge, while strong polyelectrolytes like PDADMA may complement BBL's negative charge in the reduced state directly in non-aqueous media. BBL: polyelectrolyte complexes were synthesized by reported methods,^{17, 27} mixing BBL nanoparticles and polycations or polyanions at varied ratios, with the BBL first dispersed in ethanol via solvent exchange from methanesulfonic acid, followed by mixing, washing, sonication and optional dialysis. As an alternative approach, template polymerization was also explored in which BBL is synthesized directly in the presence of a polyelectrolyte.

The ex situ and in situ characterization will proceed as outlined in Objective 1. Additional characterization can help to understand the nature of the complex, including the composition, doping level, fraction of protonation/neutralization of the polyelectrolyte, as well as the complex's colloidal properties, using methods previously applied for polyelectrolyte complexes.⁵⁸⁻⁶² Neutron activation analysis (using TAMU's cyclotron) and X-ray photoelectron spectroscopy (XPS) quantified BBL: polyelectrolyte ratios, and XPS combined with FTIR spectroscopy revealed polyelectrolyte ionization states upon complexation to understand the number of interacting polymer units;^{59, 63} dynamic light scattering and zeta potential yielded the colloidal nature of the complex. Spin-cast films were subjected to ever-increasing cyclic voltammetry potential windows to identify stability limits and examine if polyelectrolytes extend BBL's intrinsic electrochemical stability. This approach has been used in the past to identify improved stability windows in PANI: PAAMPSA complexes.³²

Complexation of BBL with polycations and polyanions yielded remarkably different optoelectronic and electrochemical properties, processability, and stability relative to BBL alone. Proton-donating polyelectrolytes improved the reversibility of BBL's redox reactions in aqueous media, as the protons can compensate the carbonyl and imidazole charges; similarly, polycations improved the reversibility of BBL in nonaqueous media, as the polycation can compensate the negative charge on reduced BBL. Both types of electrolytes further improved or widened the electrochemical window for BBL, enhancing its stability. Further, depending on whether the complex is predominantly positively or negatively charged, the transporting species switch between anions or cations, respectively, during the electrochemical redox reaction, which was revealed using EQCMD. Another significance of this objective is that it generated water-stable inks that others could use for printing for organic electronic applications.

### EXAMPLE 2—REFERENCES

1. Tropp, J.; Meli, D.; Rivnay, J., Organic mixed conductors for electrochemical transistors. Matter 2023, 6 (10), 3132-3164.
2. Kim, H.; Won, Y.; Song, H. W.; Kwon, Y.; Jun, M.; Oh, J. H., Organic Mixed Ionic-Electronic Conductors for Bioelectronic Sensors: Materials and Operation Mechanisms. Adv Sci (Weinh) 2023, e2306191.
3. Paulsen, B. D.; Tybrandt, K.; Stavrinidou, E.; Rivnay, J., Organic mixed ionic-electronic conductors. Nat Mater 2020, 19 (1), 13-26.
4. Kukhta, N. A.; Marks, A.; Luscombe, C. K., Molecular Design Strategies toward Improvement of Charge Injection and Ionic Conduction in Organic Mixed Ionic-Electronic Conductors for Organic Electrochemical Transistors. Chem Rev 2022, 122 (4), 4325-4355.
5. Gkoupidenis, P.; Zhang, Y.; Kleemann, H.; Ling, H.; Santoro, F.; Fabiano, S.; Salleo, A.; van de Burgt, Y., Organic mixed conductors for bioinspired electronics. Nature Reviews Materials 2023.
6. Lei, Y.; Li, P.; Zheng, Y.; Lei, T., Materials design and applications of n-type and ambipolar organic electrochemical transistors. Materials Chemistry Frontiers 2024, 8 (1), 133-158.
7. Yu, S.; Kousseff, C. J.; Nielsen, C. B., n-Type semiconductors for organic electrochemical transistor applications. Synthetic Metals 2023, 293.
8. Rivnay, J.; Inal, S.; Salleo, A.; Owens, R. M.; Berggren, M.; Malliaras, G. G., Organic electrochemical transistors. Nature Reviews Materials 2018, 3 (2), 17086.
9. Huang, W.; Chen, J.; Yao, Y.; Zheng, D.; Ji, X.; Feng, L. W.; Moore, D.; Glavin, N. R.; Xie, M.; Chen, Y.; Pankow, R. M.; Surendran, A.; Wang, Z.; Xia, Y.; Bai, L.; Rivnay, J.; Ping, J.; Guo, X.; Cheng, Y.; Marks, T. J.; Facchetti, A., Vertical organic electrochemical transistors for complementary circuits. Nature 2023, 613 (7944), 496-502.
10. Nan Li, Y. L., Zhe Cheng, Youdi Liu, Yahao Dai, Seounghun Kang, Songsong Li, Naisong Shan, Shinya Wai, Aidan Ziaja, Yunfei Wang, Joseph Strzalka, Wei Liu, Cheng Zhang, Xiaodan Gu, Jeffrey A. Hubbell, Bozhi Tian, Sihong Wang, Bioadhesive polymer semiconductors and transistors for intimate biointerfaces. Science 2023, 381, 686-693.
11. Inal, S.; Malliaras, G. G.; Rivnay, J., Benchmarking organic mixed conductors for transistors. Nat Commun 2017, 8 (1), 1767.
12. Sun, H.; Vagin, M.; Wang, S.; Crispin, X.; Forchheimer, R.; Berggren, M.; Fabiano, S., Complementary Logic Circuits Based on High-Performance n-Type Organic Electrochemical Transistors. Adv Mater 2018, 30 (9).
13. Wilbourn, K.; Murray, R. W., The electrochemical doping reactions of the conducting ladder polymer benzimidazobenzophenanthroline (BBL). Macromolecules 1988, 21 (1), 89-96.
14. Roberts, M. F.; Jenekhe, S. A., Lewis acid coordination complexes of polymers: 3. Poly(benzobisimidazobenzophenanthroline) ladder and semiladder polymers. Polymer 1994, 35 (20), 4313-4325.
15. Chen, X. L.; Bao, Z.; Schon, J. H.; Lovinger, A. J.; Lin, Y.-Y.; Crone, B.; Dodabalapur, A.; Batlogg, B., Ion-modulated ambipolar electrical conduction in thin-film transistors based on amorphous conjugated polymers. Applied Physics Letters 2001, 78 (2), 228-230.
16. Babel, A.; Jenekhe, S. A., High Electron Mobility in Ladder Polymer Field-Effect Transistors. Journal of the American Chemical Society 2003, 125 (45), 13656-13657.
17. Yang, C. Y.; Stoeckel, M. A.; Ruoko, T. P.; Wu, H. Y.; Liu, X.; Kolhe, N. B.; Wu, Z.; Puttisong, Y.; Musumeci, C.; Massetti, M.; Sun, H.; Xu, K.; Tu, D.; Chen, W. M.; Woo, H. Y.; Fahlman, M.; Jenekhe, S. A.; Berggren, M.; Fabiano, S., A high-conductivity n-type polymeric ink for printed electronics. Nat Commun 2021, 12 (1), 2354.
18. Cruz-Arzon, A. J.; Serrano-Garcia, W.; Pinto, N. J.; Gupta, N.; Johnson, A. T. C., Temperature dependent charge transport in electrostatically doped poly[benzimidazobenzophenanthroline] thin films. Journal of Applied Polymer Science 2022, 140(7).
19. West, S. M.; Tran, D. K.; Guo, J.; Chen, S. E.; Ginger, D. S.; Jenekhe, S. A., Phenazine-Substituted Poly(benzimidazobenzophenanthrolinedione): Electronic Structure, Thin Film Morphology, Electron Transport, and Mechanical Properties of an n-Type Semiconducting Ladder Polymer. Macromolecules 2023.
20. Giovannitti, A.; Maria, I. P.; Hanifi, D.; Donahue, M. J.; Bryant, D.; Barth, K. J.; Makdah, B. E.; Savva, A.; Moia, D.; Zetek, M.; Barnes, P. R. F.; Reid, O. G.; Inal, S.; Rumbles, G.; Malliaras, G. G.; Nelson, J.; Rivnay, J.; McCulloch, I., The Role of the Side Chain on the Performance of N-type Conjugated Polymers in Aqueous Electrolytes. Chemistry of Materials 2018, 30 (9), 2945-2953.
21. Yang, Y.; Liu, Z.; Zhang, G.; Zhang, X.; Zhang, D., The Effects of Side Chains on the Charge Mobilities and Functionalities of Semiconducting Conjugated Polymers beyond Solubilities. Advanced Materials 2019, 31 (46), 1903104.
22. Liu, Z.; Zhang, G.; Zhang, D., Modification of Side Chains of Conjugated Molecules and Polymers for Charge Mobility Enhancement and Sensing Functionality. Accounts of Chemical Research 2018, 51 (6), 1422-1432.
23. Li, X.; Li, Y.; Sarang, K.; Lutkenhaus, J.; Verduzco, R., Side-Chain Engineering for High-Performance Conjugated Polymer Batteries. Advanced Functional Materials 2021, 31 (14), 2009263.
24. Dou, J.-H.; Zheng, Y.-Q.; Lei, T.; Zhang, S.-D.; Wang, Z.; Zhang, W.-B.; Wang, J.-Y.; Pei, J., Systematic Investigation of Side-Chain Branching Position Effect on Electron Carrier Mobility in Conjugated Polymers. Advanced Functional Materials 2014, 24 (40), 6270-6278.
25. He, Y.; Kukhta, N. A.; Marks, A.; Luscombe, C. K., The effect of side chain engineering on conjugated polymers in organic electrochemical transistors for bioelectronic applications. Journal of Materials Chemistry C 2022, 10 (7), 2314-2332.
26. Noriega, R.; Rivnay, J.; Vandewal, K.; Koch, F. P. V.; Stingelin, N.; Smith, P.; Toney, M. F.; Salleo, A., A general relationship between disorder, aggregation and charge transport in conjugated polymers. Nature Materials 2013, 12 (11), 1038-1044.
27. Alam, M. M.; Jenekhe, S. A., Conducting Ladder Polymers: Insulator-to-Metal Transition and Evolution of Electronic Structure upon Protonation by Poly(styrenesulfonic Acid). The Journal of Physical Chemistry B 2002, 106 (43), 11172-11177.
28. Liu, T.; Heimonen, J.; Zhang, Q.; Yang, C. Y.; Huang, J. D.; Wu, H. Y.; Stoeckel, M. A.; van der Pol, T. P. A.; Li, Y.; Jeong, S. Y.; Marks, A.; Wang, X. Y.; Puttisong, Y.; Shimolo, A. Y.; Liu, X.; Zhang, S.; Li, Q.; Massetti, M.; Chen, W. M.; Woo, H. Y.; Pei, J.; McCulloch, I.; Gao, F.; Fahlman, M.; Kroon, R.; Fabiano, S., Ground-state electron transfer in all-polymer donor: acceptor blends enables aqueous processing of water-insoluble conjugated polymers. Nat Commun 2023, 14 (1), 8454.
29. Shi, H.; Liu, C.; Jiang, Q.; Xu, J., Effective Approaches to Improve the Electrical Conductivity of PEDOT:PSS: A Review. Advanced Electronic Materials 2015, 1 (4).
30. Groenendaal, L.; Jonas, F.; Freitag, D.; Pielartzik, H.; Reynolds, J. R., Poly(3,4-ethylenedioxythiophene) and Its Derivatives: Past, Present, and Future. Advanced Materials 2000, 12 (7), 481-494.
31. X. Crispin, F. L. E. J., A. Crispin, P. C. M. Grim, P. Andersson, A. Volodin, C. van Haesendonck, M. Van der Auweraer, W. R. Salaneck and M. Berggren, The Origin of the High Conductivity of Poly(3,4-ethylenedioxythiophene)-Poly(styrenesulfonate) (PEDOT-PSS) Plastic Electrodes. Chem. Mater. 2006, 18, 4354-4360.
32. Jeon, J.-W.; Ma, Y.; Mike, J. F.; Shao, L.; Balbuena, P. B.; Lutkenhaus, J. L., Oxidatively stable polyaniline:polyacid electrodes for electrochemical energy storage. Physical Chemistry Chemical Physics 2013, 15 (24), 9654-9662.
33. Sezen-Edmonds, M.; Loo, Y. L., Beyond Doping and Charge Balancing: How Polymer Acid Templates Impact the Properties of Conducting Polymer Complexes. J Phys Chem Lett 2017, 8 (18), 4530-4539.
34. Yoo, J. E.; Cross, J. L.; Bucholz, T. L.; Lee, K. S.; Espe, M. P.; Loo, Y.-L., Improving the electrical conductivity of polymer acid-doped polyaniline by controlling the template molecular weight. Journal of Materials Chemistry 2007, 17 (13).
35. Tarver, J.; Yoo, J. E.; Dennes, T. J.; Schwartz, J.; Loo, Y.-L., Polymer Acid Doped Polyaniline Is Electrochemically Stable Beyond pH 9. Chem. Mater. 2009, 21, 280-286.
36. Jeon, J. W.; O'Neal, J.; Shao, L.; Lutkenhaus, J. L., Charge storage in polymer acid-doped polyaniline-based layer-by-layer electrodes. ACS Appl Mater Interfaces 2013, 5 (20), 10127-36.
37. Jeon, J. W.; Ma, Y.; Mike, J. F.; Shao, L.; Balbuena, P. B.; Lutkenhaus, J. L., Oxidatively stable polyaniline: polyacid electrodes for electrochemical energy storage. Phys Chem Chem Phys 2013, 15 (24), 9654-62.
38. Jeon, J. W.; Kwon, S. R.; Li, F.; Lutkenhaus, J. L., Spray-On Polyaniline/Poly(acrylic acid) Electrodes with Enhanced Electrochemical Stability. ACS Appl Mater Interfaces 2015, 7 (43), 24150-8.
39. Jenekhe, S. A.; Johnson, P. O., Complexation-mediated solubilization and processing of rigid-chain and ladder polymers in aprotic organic solvents. Macromolecules 1990, 23 (20), 4419-4429.
40. Arnold, F. E., and R. L. Van Deusen, Preparation and properties of high molecular weight, soluble oxobenz [de] imidazobenzimidazoisoquinoline ladder polymer. Macromolecules 1969, 2, 497-502.
41. Wu, H.-Y.; Yang, C.-Y.; Li, Q.; Kolhe, N. B.; Strakosas, X.; Stoeckel, M.-A.; Wu, Z.; Jin, W.; Savvakis, M.; Kroon, R.; Tu, D.; Woo, H. Y.; Berggren, M.; Jenekhe, S. A.; Fabiano, S., Influence of Molecular Weight on the Organic Electrochemical Transistor Performance of Ladder-Type Conjugated Polymers. Advanced Materials 2022, 34 (4), 2106235.
42. Wagner, M.; Österholm, A.; Hirvonen, S. P.; Tenhu, H.; Ivaska, A.; Kvarnström, C., Characterization of Water-Dispersible n-Type Poly(benzimidazobenzophenanthroline) Derivatives. Macromolecular Chemistry and Physics 2011, 212 (15), 1567-1574.
43. Hirvonen, S.-P.; Tenhu, H., Modification of naphthalenic unit in BBL main chain. Synthetic Metals 2015, 207, 87-95.
44. Wang, Q.; Qi, J.; Qiao, W.; Wang, Z. Y., Soluble ladder conjugated polypyrrones: Synthesis, characterization and application in photodetectors. Dyes and Pigments 2015, 113, 160-164.
45. Wang, Q.; Qiao, W.; Wang, Z. Y., Facile synthesis and characterization of well-defined soluble poly(benzimidazobenzophenanthroline)-like derivatives. RSC Advances 2014, 4 (20).
46. Zhang, X.; Jenekhe, S. A., Electroluminescence of Multicomponent Conjugated Polymers. 1. Roles of Polymer/Polymer Interfaces in Emission Enhancement and Voltage-Tunable Multicolor Emission in Semiconducting Polymer/Polymer Heterojunctions. Macromolecules 2000, 33 (6), 2069-2082.
47. Ghosh, S.; Gueskine, V.; Berggren, M.; Zozoulenko, I. V., Electronic Structures and Optical Absorption of N-Type Conducting Polymers at Different Doping Levels. The Journal of Physical Chemistry C 2019, 123 (25), 15467-15476.
48. Wang, S.; Ruoko, T.-P.; Wang, G.; Riera-Galindo, S.; Hultmark, S.; Puttisong, Y.; Moro, F.; Yan, H.; Chen, W. M.; Berggren, M.; Müller, C.; Fabiano, S., Sequential Doping of Ladder-Type Conjugated Polymers for Thermally Stable n-Type Organic Conductors. ACS Applied Materials & Interfaces 2020, 12 (47), 53003-53011.
49. Tam, T. L. D.; Lin, M.; Handoko, A. D.; Lin, T. T.; Xu, J., High-performance & thermally stable n-type polymer thermoelectrics based on a benzyl viologen radical cation-doped ladder-type conjugated polymer. Journal of Materials Chemistry A 2021, 9 (19), 11787-11793.
50. Ma, T.; Yang, Y.; Johnson, D.; Hansen, K.; Xiang, S.; Thakur, R. M.; Djire, A.; Lutkenhaus, J. L., Understanding the mechanism of a conjugated ladder polymer as a stable anode for acidic polymer-air batteries. Joule 2023, 7 (10), 2261-2273.
51. Li, F.; Gore, D. N.; Wang, S.; Lutkenhaus, J. L., Unusual Internal Electron Transfer in Conjugated Radical Polymers. Angewandte Chemie International Edition 2017, 56 (33), 9856-9859.
52. Wang, S.; Easley, A. D.; Thakur, R. M.; Ma, T.; Yun, J.; Zhang, Y.; Ober, C. K.; Lutkenhaus, J. L., Quantifying internal charge transfer and mixed ion-electron transfer in conjugated radical polymers. Chemical Science 2020, 11 (36), 9962-9970.
53. Wang, S.; Li, F.; Easley, A. D.; Lutkenhaus, J. L., Real-time insight into the doping mechanism of redox-active organic radical polymers. Nature Materials 2019, 18 (1), 69-75.
54. Wang, S.; Park, A. M. G.; Flouda, P.; Easley, A. D.; Li, F.; Ma, T.; Fuchs, G. D.; Lutkenhaus, J. L., Solution-Processable Thermally Crosslinked Organic Radical Polymer Battery Cathodes. ChemSusChem 2020, 13 (9), 2371-2378.
55. Ma, T.; Easley, A. D.; Wang, S.; Flouda, P.; Lutkenhaus, J. L., Mixed electron-ion-water transfer in macromolecular radicals for metal-free aqueous batteries. Cell Reports Physical Science 2021, 2 (5).
56. Ma, T.; Li, C. H.; Thakur, R. M.; Tabor, D. P.; Lutkenhaus, J. L., The role of the electrolyte in non-conjugated radical polymers for metal-free aqueous energy storage electrodes. Nat Mater 2023, 22 (4), 495-502.
57. Thakur, R. M.; Easley, A. D.; Wang, S.; Zhang, Y.; Ober, C. K.; Lutkenhaus, J. L., Real time quantification of mixed ion and electron transfer associated with the doping of poly(3-hexylthiophene). Journal of Materials Chemistry C 2022, 10 (18), 7251-7262.
58. Zhang, Y.; Batys, P.; O'Neal, J. T.; Li, F.; Sammalkorpi, M.; Lutkenhaus, J. L., Molecular Origin of the Glass Transition in Polyelectrolyte Assemblies. ACS Central Science 2018, 4 (5), 638-644.
59. Zhang, Y.; Li, F.; Valenzuela, L. D.; Sammalkorpi, M.; Lutkenhaus, J. L., Effect of Water on the Thermal Transition Observed in Poly(allylamine hydrochloride)-Poly(acrylic acid) Complexes. Macromolecules 2016, 49 (19), 7563-7570.
60. Zhang, Y.; Yildirim, E.; Antila, H. S.; Valenzuela, L. D.; Sammalkorpi, M.; Lutkenhaus, J. L., The influence of ionic strength and mixing ratio on the colloidal stability of PDAC/PSS polyelectrolyte complexes. Soft Matter 2015, 11 (37), 7392-7401.
61. Suarez-Martinez, P. C.; Batys, P.; Sammalkorpi, M.; Lutkenhaus, J. L., Time-Temperature and Time-Water Superposition Principles Applied to Poly(allylamine)/Poly(acrylic acid) Complexes. Macromolecules 2019, 52 (8), 3066-3074.
62. Lalwani, S. M.; Batys, P.; Sammalkorpi, M.; Lutkenhaus, J. L., Relaxation Times of Solid-like Polyelectrolyte Complexes of Varying pH and Water Content. Macromolecules 2021, 54 (17), 7765-7776.
63. Lutkenhaus, J. L.; McEnnis, K.; Hammond, P. T., Nano- and microporous layer-by-layer assemblies containing linear poly(ethylenimine) and poly(acrylic acid). Macromolecules 2008, 41 (16), 6047-6054.

### Example 3

### Charge-Transfer Kinetics Analysis

To obtain the apparent diffusion coefficient of electron transfer, Dₐₚₚ, the peak current iₚ from cyclic voltammetry was plotted against the square root of scan rate, v^{1/2}. Then, Dₐₚₚ was obtained using the Randles-Sevcik equation:

$${i}_{p} = 0.4463 nFAC \sqrt{\frac{{nFvD}_{app}}{RT}} \qquad ( Equation 1 )$$

where iₚ is the peak current (A), n is the number of electrons transferred in the redox event (n=2 for each redox step), Fis Faraday's constant (96,485 C·mol⁻¹), A is the electrode area (cm²), C is the concentration of the redox species (mol/cm³), v is the scan rate (V/s), Dₐₚₚ is the diffusion coefficient (cm²/s), R is the universal gas constant (8.314 J·K⁻¹·mol⁻¹) and T is the absolute temperature (K).

The homogenous electron self-exchange rate constant Kₑₓ can be calculated from the Dahms-Ruff equation:

$${D}_{app} = \frac{1}{6} C {δ}^{2} {k}_{ex} \qquad ( Equation 2 )$$

δ is the distance the electron and the proton move, which was estimated by (N_{A}C)^{-1/3}, where N_{A} is Avogadro's number).

### Ion Diffusion Analysis

The ion diffusion coefficient Dᵢₒₙ (cm²/s) at different voltages was calculated according to the following equation using EIS:

$${D}_{ion} = 0.5 {( \frac{RT}{{AF}^{2} σ C} )}^{2} \qquad ( Equation 3 )$$

where the Warburg coefficient σ is given by the relationship of Z′=σω^{-1/2}. ω is the angular frequency in the low-frequency region and σ is the slope for the plot of Z′ vs. ω^{-1/2}.

### Electrical Conductivity Calculation

The electrical conductivity, σ was estimated by following a previous study.¹

$$σ = G \frac{d}{A} \qquad ( Equation 4 )$$

where A=3.5 mm×150 nm is the cross-sectional area through which the current is flowing, d=10 μm is the distance between the electrode, and G is the conductance.

### Calculation of the Electrochemical Metrics

The specific capacity (C, mAh/g) was calculated according to the equation below:

$$C = \frac{I Δ t}{3.6 \times m} \qquad ( Equation 5 )$$

where I is the current density (mA), Δt is the time(s), m is the mass of the active materials (mg).

The specific energy (E, Wh/kg) was calculated according to the equation below:

$$E = \frac{I \int U ( t ) dt}{3.6 \times m} \qquad ( Equation 6 )$$

In GCD tests, the voltage U(V) varies with time t(s), and the energy was calculated by integrating U(t) over t, i.e., finding the area under the charging or discharging curve.

The specific power (P, W/kg) was calculated according to the equation below:

$$P = \frac{3600 \times E}{Δ t} \qquad ( Equation 7 )$$

where E is the specific energy (Wh/kg), Δt is the time(s).

The average voltage (U_{avg}, V) at a certain current density was calculated according to the equation below:

$${U}_{avg} = \frac{E}{C} \qquad ( Equation 8 )$$

where E and C are the specific energy (Wh/kg) and the specific capacity (mAh/g) at the same current density, respectively.

### EXAMPLE 3—REFERENCES

1. Karlsson, C., Huang, H., Strømme, M., Gogoll, A., and Sjödin, M. (2015). Ion- and Electron Transport in Pyrrole/Quinone Conducting Redox Polymers Investigated by In Situ Conductivity Methods. Electrochimica Acta 179, 336-342, doi:10.1016/j.electacta.2015.02.193.
2. Choi, W., Harada, D., Oyaizu, K., and Nishide, H. (2011). Aqueous electrochemistry of poly(vinylanthraquinone) for anode-active materials in high-density and rechargeable polymer/air batteries. J Am Chem Soc 133, 19839-19843, doi:10.1021/ja206961t.
3. Li, Y., Liu, L., Liu, C., Lu, Y., Shi, R., Li, F., and Chen, J. (2019). Rechargeable Aqueous Polymer-Air Batteries Based on Polyanthraquinone Anode. Chem 5, 2159-2170, doi:10.1016/j.chempr.2019.06.001.
4. Oka, K., Furukawa, S., Murao, S., Oka, T., Nishide, H., and Oyaizu, K. (2020). Poly(dihydroxybenzoquinone): its high-density and robust charge storage capability in rechargeable acidic polymer-air batteries. Chem Commun (Camb) 56, 4055-4058, doi:10.1039/d0cc00660b.
5. Oka, K., Murao, S., Kobayashi, K., Nishide, H., and Oyaizu, K. (2020). Charge- and Proton-Storage Capability of Naphthoquinone-Substituted Poly(allylamine) as Electrode-Active Material for Polymer-Air Secondary Batteries. ACS Applied Energy Materials 3, 12019-12024, doi:10.1021/acsaem.0c02178.
6. Oka, K., Strietzel, C., Emanuelsson, R., Nishide, H., Oyaizu, K., Stromme, M., and Sjodin, M. (2020). Conducting Redox Polymer as a Robust Organic Electrode-Active Material in Acidic Aqueous Electrolyte towards Polymer-Air Secondary Batteries. ChemSusChem 13, 2280-2285, doi:10.1002/cssc.202000627.
7. Zhong, L., Fang, Z., Shu, C., Mo, C., Chen, X., and Yu, D. (2021). Redox Donor-Acceptor Conjugated Microporous Polymers as Ultralong-Lived Organic Anodes for Rechargeable Air Batteries. Angew Chem Int Ed Engl 60, 10164-10171, doi:10.1002/anie.202016746.
8. Oka, K., Murao, S., Kataoka, M., Nishide, H., and Oyaizu, K. (2021). Hydrophilic Anthraquinone-Substituted Polymer: Its Environmentally Friendly Preparation and Efficient Charge/Proton-Storage Capability for Polymer-Air Secondary Batteries. Macromolecules 54, 4854-4859, doi:10.1021/acs.macromol. 1c00865.
9. Kawai, T., Oyaizu, K., and Nishide, H. (2015). High-Density and Robust Charge Storage with Poly(anthraquinone-substituted norbornene) for Organic Electrode-Active Materials in Polymer-Air Secondary Batteries. Macromolecules 48, 2429-2434, doi:10.1021/ma502396r.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. An acidic polymer-air battery, comprising:
an anode that comprises a conjugated ladder polymer having the following structure: 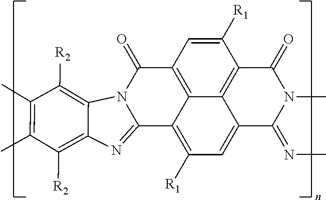
wherein each R₁ and each R₂ are independently selected from H, an alkyl, an ethylene oxide, a charge group, one or more of the structures shown below: 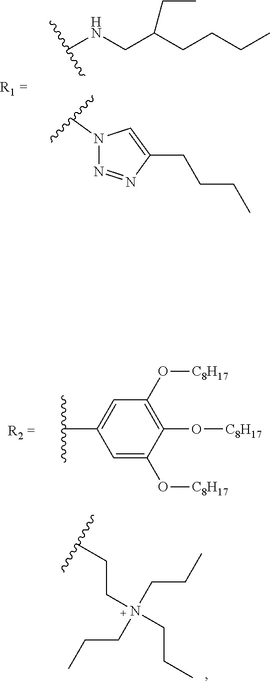
or a combination of any thereof.

2. The acidic polymer-air battery of claim 1, wherein R₁ and R₂ are H.

3. The acidic polymer-air battery of claim 1, wherein R₁ and R₂ are independently selected from an alkyl, an ethylene oxide, a charge group, one or more of the structures shown below: 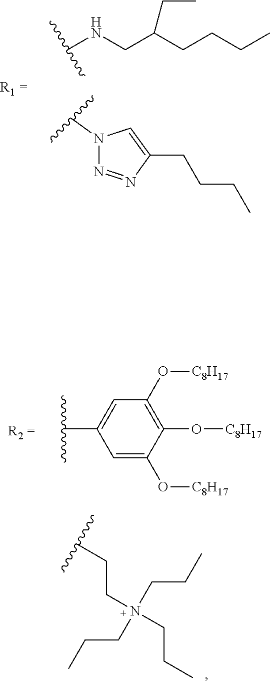
or a combination of any thereof.

4. The acidic polymer-air battery of claim 1, wherein anode further comprises:
an additive material selected from: carbon materials, conducting polymers, conductive wire and sheets, or a combination of any thereof.

5. The acidic polymer-air battery of claim 1, wherein a weight-to-weight ratio of polymer to additive material is about 30:70 to 100:0.01.

6. The acidic polymer-air battery of claim 1, wherein the anode further comprises a polyelectrolyte additive.

7. The acidic polymer-air battery of claim 6, wherein the conjugated ladder polymer to polyelectrolyte ratio is about 100:0.01 to about 30:70.

8. The acidic polymer-air battery of claim 1, further comprising a cathode that comprises an air cathode.

9. The acidic polymer-air battery of claim 8, wherein the air cathode comprises a plurality of platinum (Pt) nanoparticles on a surface of a porous carbon (C) support.

10. The acidic polymer-air battery of claim 8, further comprising an electrolyte between the anode and the cathode.

11. The acidic polymer-air battery of claim 10, wherein the electrolyte comprises H₂SO₄.

12. The acidic polymer-air battery of claim 10, further comprising a glass fiber separator within the electrolyte between the anode and the cathode.

13. A method of assembling an acidic polymer-air battery, comprising:
placing an anode within a battery housing, wherein the anode comprises a conjugated ladder polymer having the following structure: 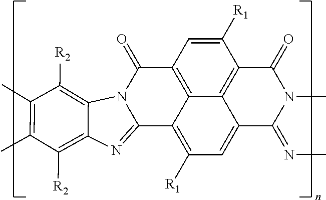
wherein each R₁ and each R₂ are independently selected from H, an alkyl, an ethylene oxide, a charge group, one or more of the structures shown below: 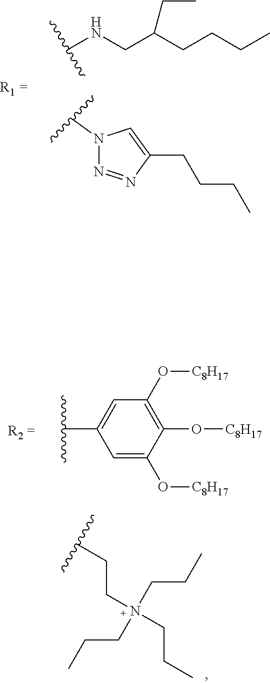
or a combination of any thereof.

14. The method of claim 13, wherein R₁ and R₂ are H.

15. The method of claim 13, wherein R₁ and R₂ are an alkyl, an ethylene oxide, a charge group, one or more of the structures shown below: 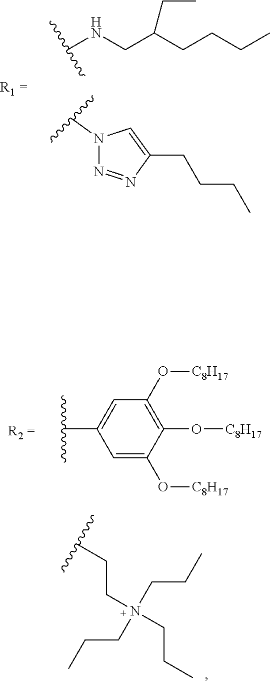
or a combination of any thereof.

16. The method of claim 13, wherein anode further comprises:
an additive material selected from: carbon materials, conducting polymers, conductive wire and sheets, or a combination of any thereof.

17. The method of claim 13, further comprising:
placing an air cathode within the battery housing at an opposite end of the battery housing to the anode;
placing a separator within the battery housing between the anode and the cathode; and
filling the battery housing with an electrolyte.

18. The method of claim 17, further comprising sealing the battery housing.

19. The method of claim 17, wherein the electrolyte comprises one or more of the following: H₂SO₄, HCl, acetic acid, or phosphoric acid.

20. The method of claim 17, wherein the air cathode comprises a plurality of platinum (Pt) nanoparticles on a surface of a porous carbon (C) support.
